(19) United States
(12) Patent Application Publication
(10) Pub. No.: US 2011/0242305 A1
(43) Pub. Date: Oct. 6, 2011

(54) Immersive Multimedia Terminal

(76) Inventors: Harry W. Peterson, San Jose, CA (US); Erik Yann Peterson, San Jose, CA (US); Jean Gabriel Peterson, San Jose, CA (US); Diana Hawkins Manuelian, Atherton, CA (US)

(21) Appl. No.: 13/078,322

(22) Filed: Apr. 1, 2011

Related U.S. Application Data
(60) Provisional application No. 61/341,526, filed on Apr. 1, 2010.

(51) Int. Cl. H04N 7/18; G09G 5/00; G01S 15/00

(52) U.S. Cl. 348/77; 345/156; 367/87; 367/99; 348/E07.085

(57) ABSTRACT

Various embodiments of the present invention teach an advantageous means of conducting and controlling multimedia communication. Real-world communication involving sight, sound and body language is fully supported, without requiring that the user wear or touch any special apparatus. A novel Device-Area-Network (DAN) method is introduced to allow devices contained in compatible apparatus external to the Immersive Multimedia Terminal (IMT) to be discovered and fused to the devices within the IMT. Said method allows seamless integration of cellphones, laptops and other compatible apparatus so that they can use the IMT as a high-performance terminal. Said method also allows the IMT to fully integrate resources that exist in said external compatible apparatus. Examples of said resources are microphones, environmental sensors, disk drives, flash memory, cameras, and wired or wireless communication links.

### CROSS-REFERENCE TO RELATED APPLICATIONS

This application claims benefit of and priority to U.S. provisional patent application 61/341,526 filed Apr. 1, 2010 and entitled “Immersive multimedia terminal with integral system for gesture recognition and presence detection.” The above application is hereby incorporated herein by reference.

### BACKGROUND OF THE INVENTION

1. Field of the Invention

The invention is in the field of computing systems and more specifically in the field of human machine interaction.

2. Description of the Prior Art

Wave Field Synthesis

Wave Field Synthesis (WFS) is a body of knowledge that has grown from the need for efficient acoustic sensing of geological formations that contain oil or valuable minerals.

Immersive Multimedia

Immersive multimedia can convey many or all of the human senses that have been used for ordinary communication. Such modes of communication include seeing, hearing, speaking, and making gestures. The advantages of using immersive multimedia communication as a substitute for actual physical presence include economy, efficiency, convenience and safety.

Human-Computer Interface and Gesture Recognition

Human Computer Interaction (HCI) relies on highly efficient, bi-directional interaction between the natural environment (users, physical space, etc.) and the synthetic systems (hardware, software, etc.). Gesture Recognition (GR) is frequently used as a means that allows humans to assert control within the context of an HCI. Communication from human to computer is most commonly accomplished by keyboard, mouse, voice recognition, gesture recognition, and mechanical input devices such as foot-switches.

The most common forms of gesture recognition include: 1) physically detecting gestures made by one or more fingers sliding on the two-dimensional surface of a synthetic touchpad; 2) physically detecting position coordinates and state of pushed buttons on a mouse; and 3) use of one or more cameras to visually detect position and motion of a user.

Communication from computer to human is most commonly accomplished by video displays. In order to get maximum benefit from display resolution, numerous ‘back-channel’ techniques have been devised to allow users to configure displays for optimal information density. For example, the mouse can be used to define and manage windows. As displays become higher-resolution and 3D, there is a need for more sophisticated ‘back-channel’ means of configuring and optimizing displays.

### SUMMARY

Various embodiments of the invention include a system that provides any combination of the following capabilities within a single apparatus:
1. Phase coherent array microphone, which captures the Wave Field.
   Because the microphone is phase coherent, it is possible to separate the desired acoustic energy (usually the speech coming from the mouth of the user) from the undesired acoustic energy (usually noise or speech coming from other parts of the room in which the apparatus is located).
2. Gesture recognition reliant upon real-time localization of objects.
3. Imaging systems configured to provide real-time monographic or stereographic images of users in order to determine location of their lips and correlation between lip movements and acoustic signals sensed by the phase coherent microphone.
   Said imaging system may be based on stereographic, acoustic or electromagnetic sensing systems. Said acoustic systems are optionally configured to emit and receive ultrasound radiation typically in the range 20-100 kHz and to image by means of SONAR. Said electromagnetic systems are optionally based on illumination and detection of visible or infrared light. Said stereographic imaging systems typically allow the Immersive Multimedia Terminal (IMT) to convey three-dimensional images of the user. Said imaging system may employ multiple sensing means in order to improve quality of the images.
4. Analysis systems configured to infer meaning of gestures.
5. Radio Frequency Identification (RFID) systems configured to provide ranging information to indicate location of tags worn by users and also provides information such as security authorization associated with said tags.
6. Device Area Network (DAN) systems configured to provide beacon and communication capability that allow compatible devices to initiate the process of network discovery, simultaneous localization and mapping, ad-hoc network formation and information transfer. The DAN systems may be wired or wireless. The DAN systems may employ both electromagnetic and acoustic communication means. Said electromagnetic means can provide clock signals that have negligible skew among devices within DAN systems, as a consequence of the fact that light propagates much faster than sound.
7. Acoustic or electromagnetic ranging systems configured to allow compatible devices to adaptively maintain mutual calibration information and aggregate their sense capability in order to improve the performance of the original IMT.
8. Display systems employing one or more frontside-illumination short-throw projectors.
   These display systems may use stereoscopic or autostereoscopic 3-D technology in order to make advantageous use of the human capability to see in three dimensions.
9. Super Resolution systems configured to allow utilization of multiple projectors for video illumination of display screens of arbitrary shape.
10. Systems consisting of a plurality of Immersive Multimedia Terminals (IMTs) are connected by means of a network. Said systems may be configured for remote control and optimization of devices within any other IMT. Said control or optimization can be implemented by using a portion of the bandwidth of the al link that provides connectivity for the audio or video signals passed between or among the plurality of IMTs.

Various embodiments of the invention include spatially-distributed acoustic sensors embedded within a 2D or 3D display screen and configured to accurately sense the acoustic field and energy over a frequency range that includes audible frequencies and ultrasound frequencies. Said sensors are able to operate in real time and to measure both amplitude and spatial characteristics of said acoustic energy. Said sensors can function as an array microphone that delivers holographic audio, in order to provide high-fidelity voice communication and high-accuracy voice recognition. Said sensors can also function as a spatially distributed ultrasound imaging device.

In some embodiments of the invention, ultrasound emitters are placed at one or more points within or around a display. These emitters illuminate the local natural spatial field with an ultrasound signal. Reflected ultrasound energy is received by spatially-distributed acoustic sensors, which function as an ultrasonic imaging device as well as a phase-coherent array microphone. This phase-coherent, mutimodal (audible and ultrasonic) system provides natural, unaided gesture recognition and high-fidelity audio functionality.

Various embodiments of the invention include IMTs having multiple imaging systems, such as RF ranging, ultrasound imaging, and video imaging. These IMTs are optionally configured to bond with other devices such as cell phones and then aggregate services provided by those other devices. If this bonding is done with timing and communication devices of adequate precision, acoustic sensors within the aggregate apparatus will be phase-coherent.

In some embodiments, the present invention fuses information gained from multiple sensing devices in order to improve accuracy and versatility of a gesture recognition system.

In various embodiments, an IMT includes a computation system configured to control operational parameters. In a default mode, IMT operation is fully automated. Operation in the default mode is designed to be very intuitive, so that no operator experience or training is typically required. Users assert control by means of gestures, spoken commands, or physical input devices such as keyboards. Non-default modes are optionally provided for users who require additional sophistication. In an embodiment, users can put the IMT into a ‘learn’ mode in order to augment the gesture-recognition and speech-recognition vocabulary.

In various embodiments. IMT control can be asserted by the local user, a remote user, a director, or a robot. These embodiments include arbitration systems configured for managing contention among sources of control.

Various embodiments include timing systems configured to measure spatial coordinates of acoustic signals by determining times when transducers or sensors generate and receive signals.

In various embodiments, the sensors and transducers within the IMT include devices that comprise a device-area-network (DAN). The DAN allows data transport with bandwidth and latency that are sufficiently good to support the phase coherence of the relevant sensors. Because the speed of sound is orders of magnitude slower than the speed of light, the timing constraints that apply to SONAR localization are much less severe than the timing constraints that apply to RADAR localization. Some embodiments include a method for achieving both RADAR and SONAR localization while using timing means that can easily be realized within the bounds of current technology. In various embodiments, said devices can be admitted to or expelled from the DAN under user control.

In various embodiments, the IMT includes a microphone system. For example, in an embodiment, the IMT includes a microphone array having a highly linear phase response. The microphone array is optionally configured to suppress noise, clutter and/or undesired signals that could otherwise impair intelligibility. In embodiments including a Cisco Telepresence phone, this feature is achieved by simply monitoring signal amplitude and choosing to suppress signals from all microphones except the one that provides highest signal amplitude. At cost of greater complexity, phase-coherent microphones can be arranged to exploit the superior results available with beamforming.

In an embodiment of the IMT, the microphone system also serves as detection system for ultrasound signals. When combined with an ultrasound illumination system, said microphone systems allow imaging of objects or persons that are in front of the screens. This embodiment optionally includes a method for using ultrasound imaging within a designated Gesture-Recognition-Volume (GRV). Typically, the designated GRV will be the volume that the user's torso, head and hands occupy while he is using the IMT.

In some embodiments, to use said ultrasound imaging system for the purpose of gesture recognition, the user simply needs to make a physical gesture. Winking, waving, pointing, pinching the fingers, and shrugging the shoulders are examples of physical gestures that the IMT can recognize.

The resolution available from ultrasound imaging systems is on the order of the wavelength of the ultrasound signal.

Wavelength=speed of sound/frequency

At sea level, the speed of sound is approximately 343 meters per second. So, an ultrasound signal of 40 kHz will have a wavelength of approximately 9 millimeters. Therefore, ultrasound imaging provides adequate resolution for recognizing gestures made by human fingers, hands, heads, shoulders, etc.

By definition, ultrasound transducers emit acoustic energy at frequencies higher than those audible to the human ear. Ultrasound systems, in various embodiments, allow generation of pulses of arbitrary shape and amplitude. For example, it is possible to use an electrical sine wave to generate a continuous tone of a given frequency. And it is possible to generate an acoustic chirp, impulse, or wavelet by using an electrical waveform of the corresponding type.

Typical RFID systems comprise an RFID tag operating at a frequency between 1 GHz and 100 GHz. In various embodiments said RFID tag typically contains energy-harvesting circuitry, local memory, and an RF transmitter. The local memory allows storage of data such as identification and security authorization. The RFID tag is typically worn on the person of the user. For example, if the user is a surgeon in an operating room, the RFID tag typically is embedded in his surgical glove.

In some embodiments, a plurality of RF transceivers are incorporated in the IMT.

In various embodiments these spatially-distributed transceivers communicate with one or more RFID tags. The transceivers generate an RF field that can power the RFID tags and cause them to respond with transmissions that carry encoded data such as ID and security authorization. Said transmissions can be mined in order to ascertain location of each RFID tag.

In some embodiments, these transceivers communicate with other compatible devices that are nearby. In the event that said other devices possess useful sense capabilities, they can join the IMT device-area-network and augment it.

### BRIEF DESCRIPTION OF DRAWINGS

FIG. 1 illustrates an Immersive Multimedia Terminal with Integral System for Gesture Recognition and Presence Detection, according to various embodiments of the invention

FIG. 2 illustrates a SONAR imaging system configured for gesture recognition, according to various embodiments of the invention.

FIG. 3 provides a block diagram of SONAR imaging system, according to various embodiments of the invention.

FIG. 4 illustrates a method for inferring location of an object by using triangulation and SONAR, according to various embodiments of the invention.

FIG. 5 provides a perspective view of the screen fixture and SONAR devices, according to various embodiments of the invention.

FIG. 6 provides a top view of the screen fixture and SONAR devices, according to various embodiments of the invention.

FIG. 7 provides a front view of the screen fixture and SONAR devices, according to various embodiments of the invention.

FIG. 8 provides a perspective view of the screen fixture and an object being imaged, according to various embodiments of the invention.

FIG. 9 shows the first of three triangles used for localization of imaged object, according to various embodiments of the invention.

FIG. 10 shows the second of three triangles used for localization of imaged object, according to various embodiments of the invention.

FIG. 11 shows the arc traced by the vertex of the first triangle, according to various embodiments of the invention.

FIG. 12 shows the arc traced by the vertex of the second triangle, according to various embodiments of the invention.

FIG. 13 shows the intersection of arcs defining a point where object α1 is located, according to various embodiments of the invention.

FIG. 14 shows the third of three triangles used for localization of imaged object, according to various embodiments of the invention.

FIG. 15 shows a top-level view of the sensitive region for a typical SONAR unit, according to various embodiments of the invention.

FIG. 16 shows a Gesture Recognition Volume (GRV) consisting of the space where sensitive regions of SONAR units overlap, according to various embodiments of the invention.

FIG. 17 shows modifying a sensitive region of a SONAR unit to effect change in location and size of GRV, according to various embodiments of the invention.

FIG. 18 shows a Doppler shift caused by nonzero velocity of moving reflective object, according to various embodiments of the invention.

FIG. 19 shows a time-domain view of the wavelet of ultrasound energy which comprises a SONAR pulse sent from 41, according to various embodiments of the invention.

FIG. 20 shows a frequency-domain view of said wavelet, as seen at 41, according to various embodiments of the invention.

FIG. 21 shows a frequency-domain view of said wavelet, as seen at moving object 201, according to various embodiments of the invention.

FIG. 22 shows a frequency-domain view of said wavelet, as seen at 41 after reflection from object 201, according to various embodiments of the invention.

FIG. 23 shows an imaging system with four SONAR units, according to various embodiments of the invention.

FIG. 24 shows SONAR devices which comprise a Device Area Network, according to various embodiments of the invention.

FIG. 25 shows physical details of the experimental setup, according to various embodiments of the invention.

FIG. 26 shows gesture, according to various embodiments of the invention.

FIG. 27 shows inference of localization information by four SONAR units, at beginning of gesture, according to various embodiments of the invention.

FIG. 28 shows inference of localization information by four SONAR units, at middle of gesture, according to various embodiments of the invention.

FIG. 29 shows inference of localization information by four SONAR units, at end of gesture, according to various embodiments of the invention.

FIG. 30 illustrates Phase Coherent Array Microphone integration with screen fixture and gesture recognition system, according to various embodiments of the invention.

FIG. 31 shows SONAR units sequentially illuminating all objects within GRV, according to various embodiments of the invention.

FIG. 32 shows ultrasonic illumination reflected by all objects within GRV, according to various embodiments of the invention.

FIG. 33 shows three Immersive Multimedia Terminals in a telepresence application, according to various embodiments of the invention.

FIG. 34 shows Users, Display and External Compatible Devices in an Immersive Multimedia Terminal, according to various embodiments of the invention.

FIG. 35 shows ultrasound emitters of an Immersive Multimedia Terminal, according to various embodiments of the invention.

FIG. 36 shows integration of camera elements within an Immersive Multimedia Terminal, according to various embodiments of the invention.

FIG. 37 shows a surgeon can wear RFID means in a disposable glove to disambiguate, identify and to temporarily convey security authorization, according to various embodiments of the invention.

FIG. 38 shows a Chalkboard with electronic chalk, according to various embodiments of the invention

FIG. 39 shows a flowchart, according to various embodiments of the invention.

FIG. 40 shows a flowchart, according to various embodiments of the invention.

FIG. 41 shows a state diagram, according to various embodiments of the invention.

FIG. 42 illustrates the use of RFID devices embedded within the IMT or any device which joins the DAN, according to various embodiments of the invention.

FIG. 43 illustrates that RFID devices may be attached to any person who is using the IMT, according to various embodiments of the invention.

FIG. 44 shows a flowchart, according to various embodiments of the invention.

FIG. 45 shows the structure of the signals used for discovery, calibration and configuration of devices which join the DAN, according to various embodiments of the invention.

FIGS. 46-48 show coding schemes according to various embodiments of the invention.

FIG. 49 shows a block diagram of an RFID chip, according to various embodiments of the invention.

FIG. 50 shows a block diagram of acoustic receiver channel, according to various embodiments of the invention.

FIG. 51 shows a block diagram of acoustic receiver channel, according to various embodiments of the invention.

FIG. 52 shows a block diagram of acoustic receiver channel, according to various embodiments of the invention.

FIG. 53 shows a block diagram of ultrasound transmitter unit, according to various embodiments of the invention.

### DETAILED DESCRIPTION OF THE INVENTION

Glossary:

DAN: Device Area network

GR: Gesture Recognition

GRS: Gesture Recognition System

GRV: Gesture Recognition Volume

HCI: Human Computer Interaction

ID: Identification

IMT: Immersive Multimedia Terminal

MEMS: MicroElectroMechanical System

PCAM: Phase Coherent Array Microphone

RF: Radio Frequency

RFID: Radio Frequency Identification

RS: Recognition Space

SONAR: Sound Navigation And Ranging

WFS: Wave Field Synthesis

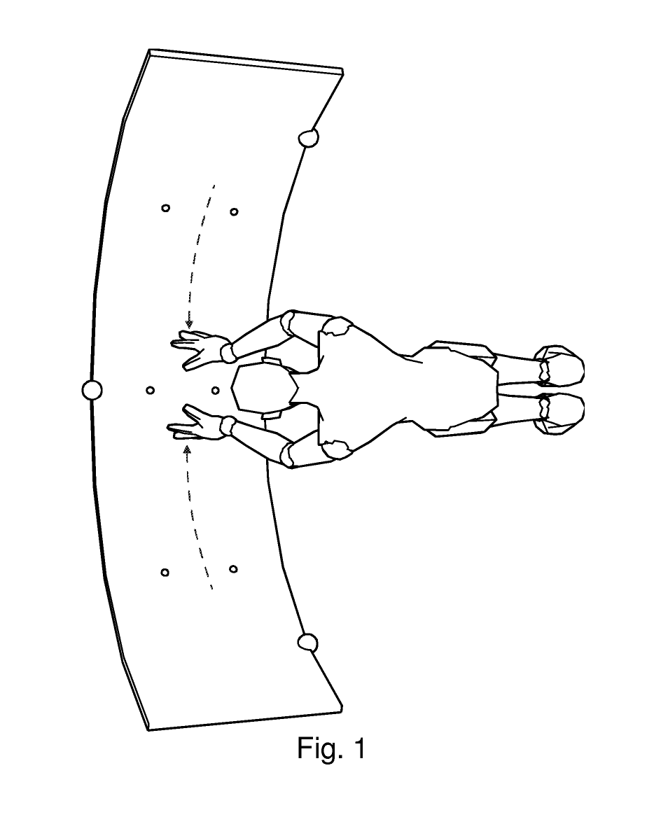

A first embodiment of the present invention is a Phase Coherent Array Microphone (PCAM) including integral Gesture Recognition System (GRS). FIG. 1 shows a typical use case for this invention.

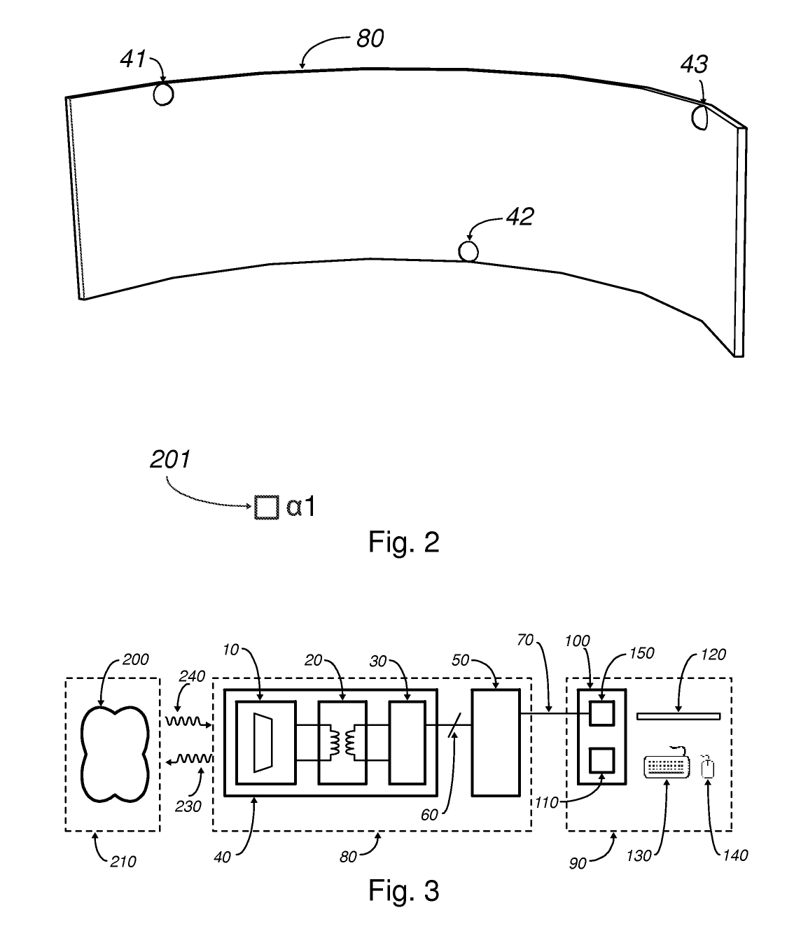

FIG. 2 shows how the first embodiment integrates the GRS can be integrated with the screen element and the PCAM. Sensors and transducers embedded within the screen or adjacent to the screen are providing real-time localization of whatever persons or objects may be in front of the screen. This real-time localization information can be analyzed in order to infer gestures with which the user intends to control and communicate. Screen element 80 optionally can be a display screen or a mechanical framework for holding devices that comprise the PCAM and its integral GRS. Object 201 can be any type of inanimate physical thing, or any type of animate thing, such as a finger, a hand, a face, or a person's lips. In many use cases, there will be a set of objects 201. Examples of common use cases for the present invention involve a set of objects 201 that include arbitrary distributed things and shapes, such as a human torso.

In this first embodiment, there are three or more SONAR units 41, 42, 43. Each SONAR unit contains an ultrasound emitter co-located with an ultrasound sensor. This co-location may be achieved by configuring each transducer element so it will function both as emitter and as sensor.

The first embodiment uses SONAR for imaging objects or persons 201. In prior-art systems, video has been used for such detection. Video provides about four orders of magnitude higher resolution than SONAR. This extra resolution has a cost but does not bring substantial benefit in the case of gesture recognition. The ultrasound imaging system has adequate resolution (better than 1 cm) for gesture recognition (GR). Also, it is advantageous to have GR functionality even when the video system is not powered. For example, this allows use of gestures to actually turn the video system on. If both ultrasound and video imaging means are available, imaging information is advantageously combined by means of Bayesian fusion to produce images of higher quality than those that could be gained by only using one of said imaging ans.

To validate the concept, SONAR localization subsystem of this first embodiment was built using off-the-shelf hardware as follows:

3×[MaxBotix MB1220 XL-MaxSonar-EZ2] SONAR unit ultrasound transceiver)

1×[Opal-Kelly XEM3001] FPGA w/USB2 interface

1×[custom screen fixture] physically holds components listed above

1×[desktop computer with USB2 and nVidia GPU] host PC.

FIG. 2 shows a system consisting of three emitters and three receivers. FIG. 2 shows location of emitter and receiver elements used in the first embodiment. In this first embodiment, transducers are used that serve as both emitter and receiver elements. The emitters send ultrasound acoustic energy to object 201, which reflects said energy.

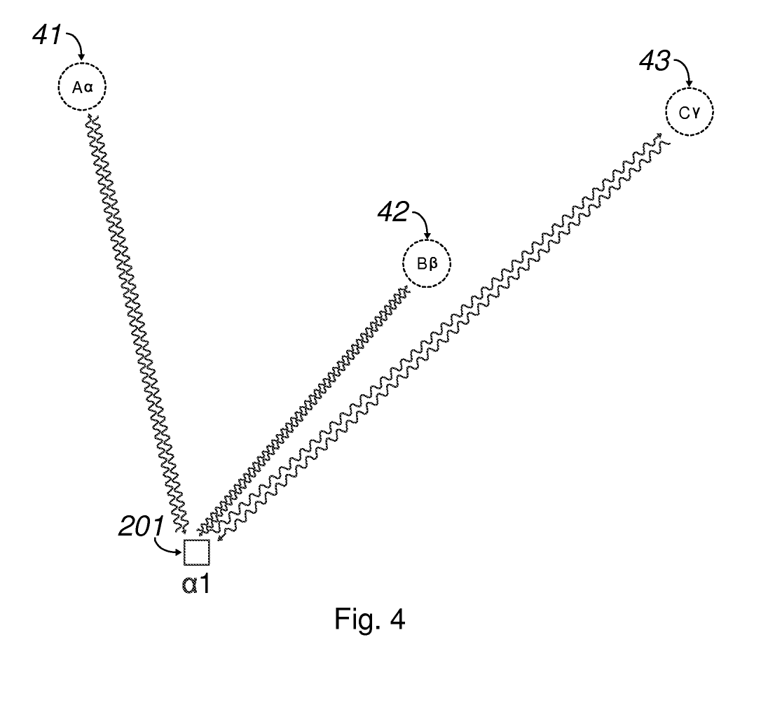

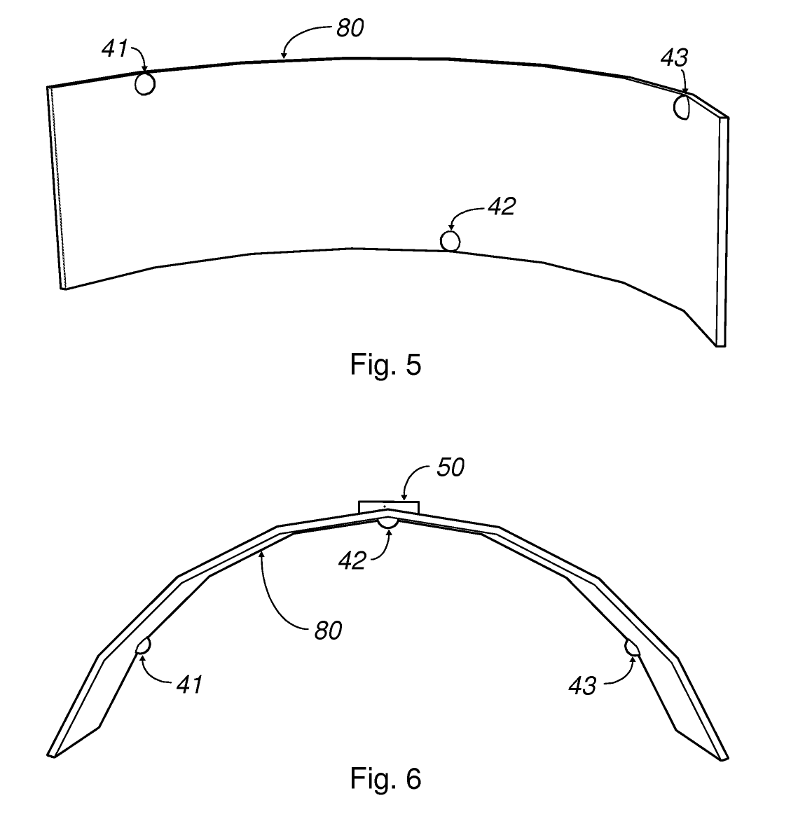

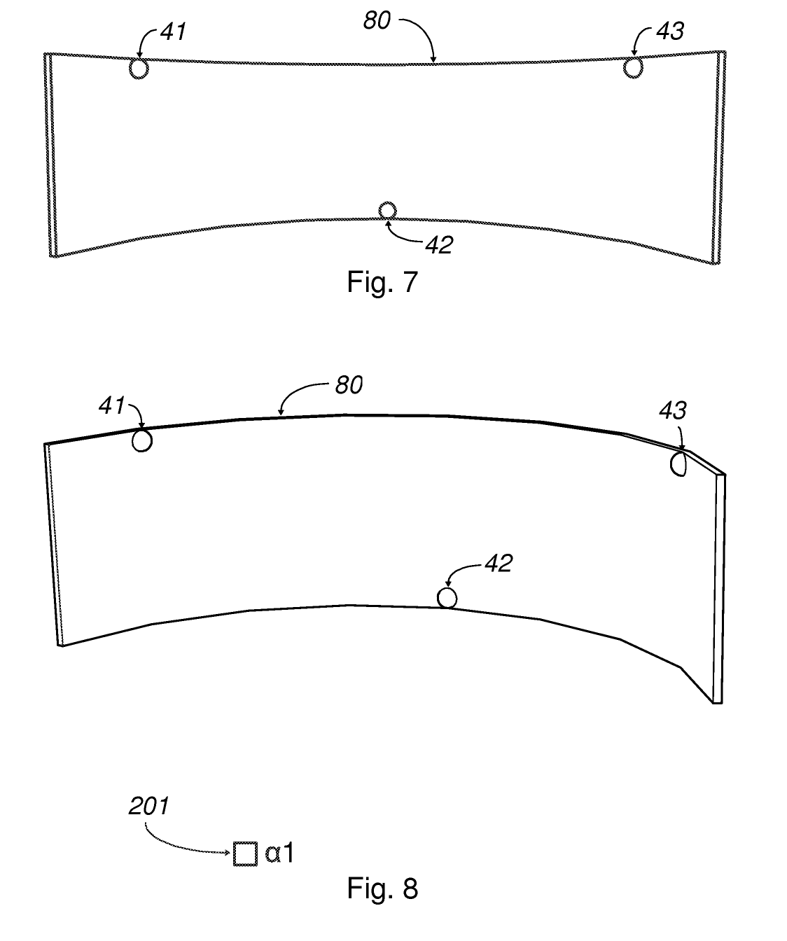

In the several drawings α, β, γ are emitters of ultrasonic energy and A, B, C are receivers of ultrasonic energy. In the first embodiment, elements A and α are located at the same point in space, which is shown as (41) in FIG. 2. Similarly, B and β are at point (42) and C and γ are at point (43) (see FIG. 4).

If points 41, 42 and 43 are collinear, then it is generally impossible to unambiguously identify the location of object 201 where acoustic energy is reflected. If points 41, 42 and 43 are not collinear, and if points 41, 42 and 43 are directional or on a flat or curved surface that causes them to be acoustically isolated from any sound sources located on the remote side of said surface, then it is possible to uniquely identify the spatial coordinates of object 201.

Assuming the speed of sound and the coordinates of SONAR devices 41, 42, 43 are known, measuring the Time Delay of Arrival (TDOA) of audio signals reflected by object 201 allows triangulation to, and computation of, spatial coordinates of object 201.

Each of the MB1220 SONAR devices contains a single transducer which serves as both emitter (TX) and receiver (RX). Each TX/RX pair functions as an isolated unit. In other words, other RX units like the ones in 42, 43 are optionally not used to sense the TX signal emitted by 41. Other embodiments taught elsewhere herein advantageously change the SONAR configuration so that multiple RX units can achieve phase-coherent detection of ultrasound energy emitted by any given TX unit.

Nomenclature:

Pinger==The SONAR unit (e.g. MB1220)

Espejo==The physical object that is reflecting acoustic energy from the Pinger

The minimal system has three Pingers==p1, p2, p3. Pingers p1, p2 and p3 are SONAR devices at location 41, 42 and 43, respectively. Coordinates of pinger i are (xpi, ypi, zpi) and coordinates of espejo αj are (xαj, yαj, zαj). ‘Pinger’ and ‘espejo’ are assumed to be very small and can therefore be treated as points. ‘Small’ as used herein means that the physical dimension is smaller than ˜λ/2, where λ is the wavelength of ultrasound energy. Typically the system images with ultrasound signals of frequency 42 to 100 kHz. Under nominal conditions (dry atmospheric conditions at sea level), λ/2=(340 m/sec)/100 kHz/2=1.7 mm. Consequently, embodiments of the present invention are capable of resolving images of things much smaller than the width of a human finger.

Resolution improves linearly with the frequency of the ultrasound signal. Traditional ultrasound ranging systems commonly operate at 42 kHz. The system functions correctly with 42 kHz signals but benefits from use of higher frequencies such as 100 kHz. To achieve 100 kHz operation, the present system can use MEMs microphones whose diaphragms are optimized for self-resonance at or above 100 kHz. Additionally, the data converter can be sampled at relatively high frequency in order to ensure good sensitivity. For example, when the data converter is implemented as a sigma-delta circuit with oversampling of 64 times, the data converter can be operated at approximately 6.4MSPS in order to optimize sensitivity and frequency response. Optionally, the data converter can be a bandpass sigma-delta converter in order to reduce power and reject low-frequency interference.

It is often desirable to use the microphones within the SONAR units to detect both the ultrasound signals and the audible signals. The data converter can be built with a common front end that handles both audible signals and ultrasonic signals and separate back ends which have sigma-delta architectures that are separately optimized for audible and ultrasound signals. Alternatively, a single wide-band front end followed by a single wide-bandwidth sigma-delta can sample both the audible and the ultrasound signals. The output of said data converter is a digital stream which can be fed to finite-impulse-response filters that serve as a diplexer and separate the audio and ultrasound signals.

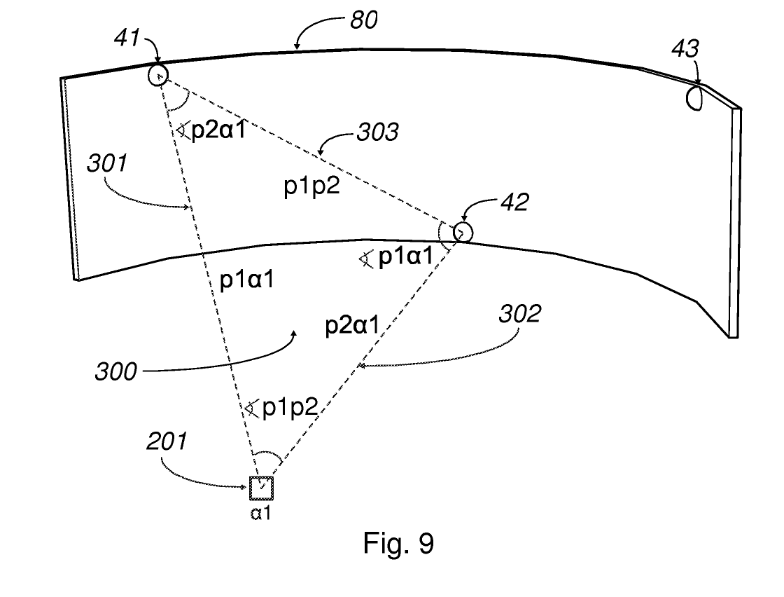

In the system described above, localization of a single small object al can be achieved as follows (see FIG. 9):

1. visualize the relevant triangles

2. write down the law of sines

3. plug in the lengths of the sides of the triangles

4. solve for (xα1, yα1, zα1).

Object 201 is the espejo while 41, 42, and 43 represent pingers 1, 2, 3. There are three relevant triangles. One of them is sketched as object 300 in FIG. 9. Length of side p1p2 is known because it is one of the dimensions of the screen fixture 80. Lengths of sides p1α1 and p2α1 are measured by the pingers 41 and 42, respectively.

Notation:

Let a==length (p1α1), b==length (p2α1), c==length (p1p2)

and A==included angle (p1α1), B==included angle (p2α1), C==included angle (p1p2)

Because a is already known and SONAR is used to solve for b and c, the system can solve part of the problem. Specifically, the system can solve to find the arc that 201 is on. To then find the coordinate of object 201, the system needs to use more of the information gathered in the measurement.

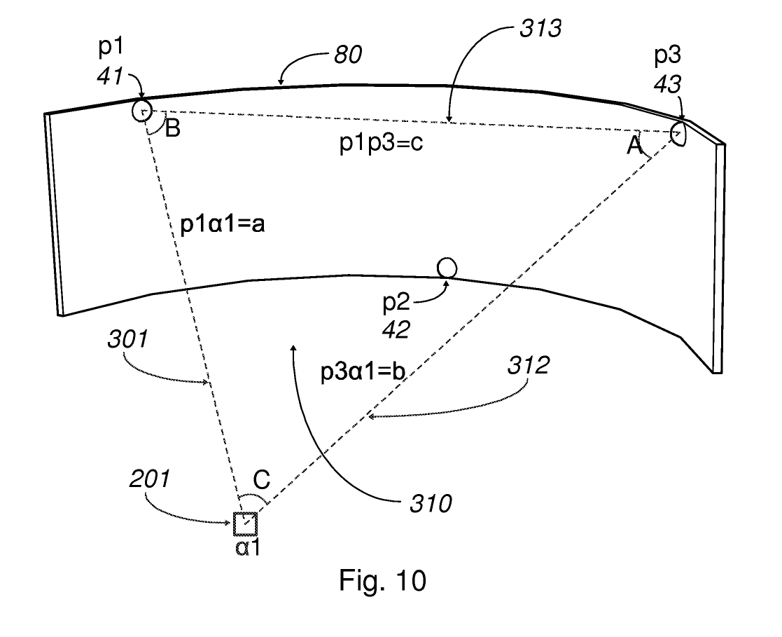

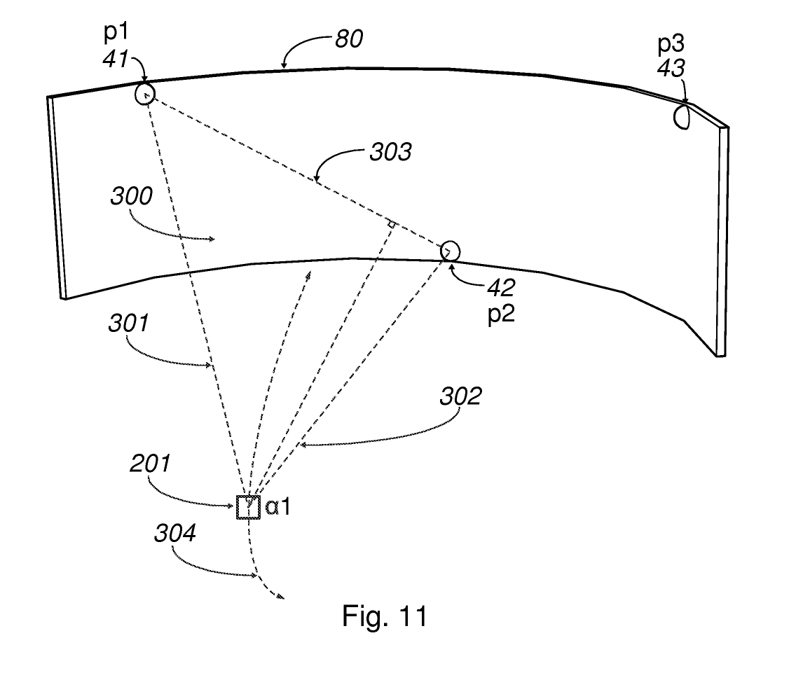

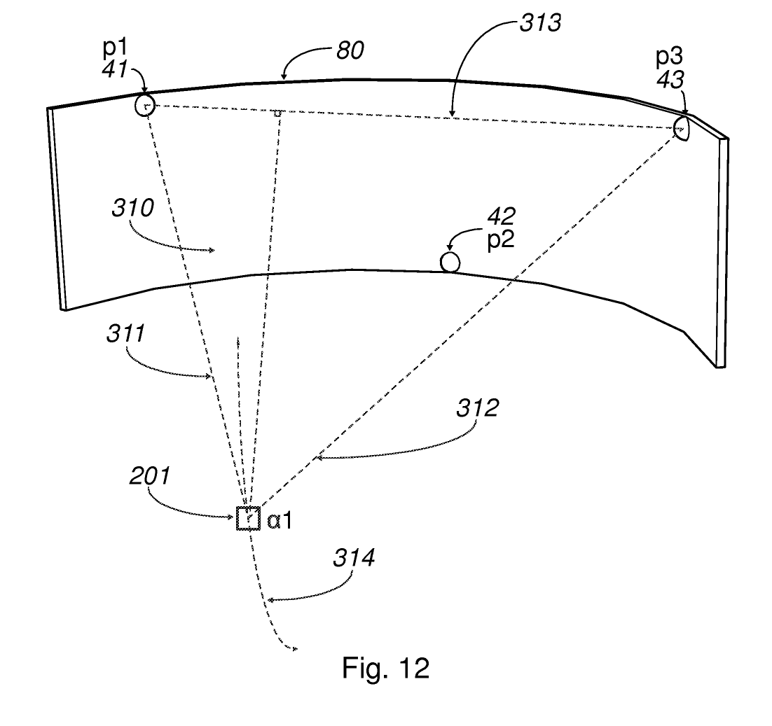

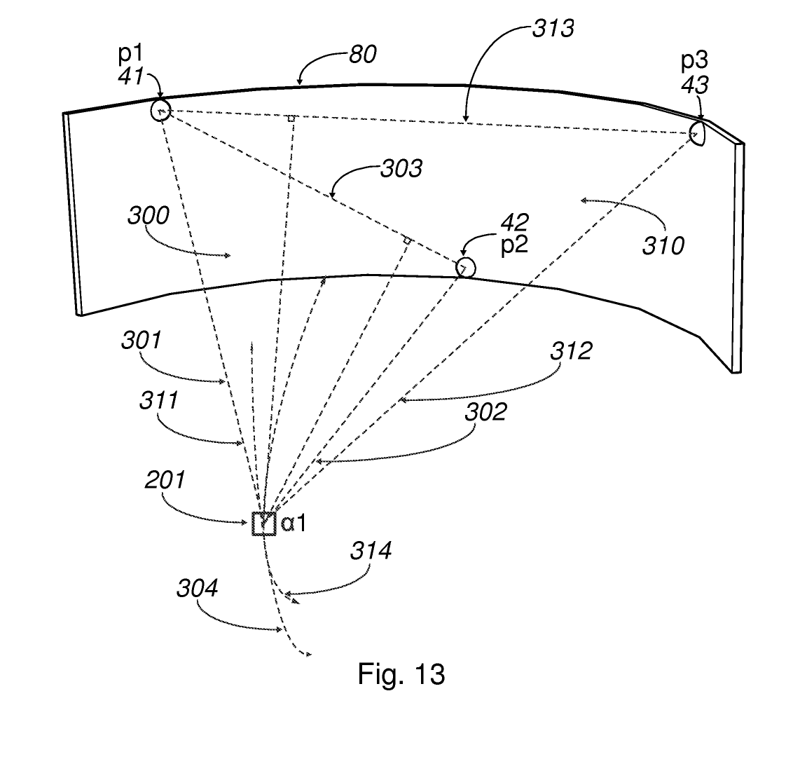

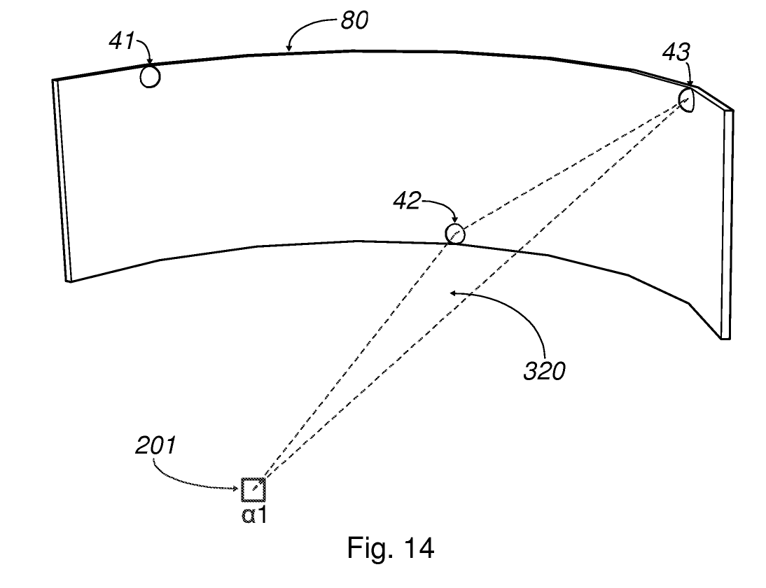

FIG. 10 shows the second triangle (310) used for localization of object 201. FIGS. 11 and 12 help visualize the solution to this triangulation problem. Imagine that there is a hinge that fixes lines 303 and 313 but allows triangles 300 and 310 to rotate, and visualize these hinges as they are flexed. As triangle 300 rotates, the vertex defined by the intersection of lines 301 and 302 will travel along arc 304. Similarly, as triangle 310 rotates, the vertex defined by the intersection of lines 311 and 312 will travel along arc 314. The intersection of these two arcs is the point where object 201 is located. If line 313 is visualized as a hinge for triangle 310, the opposite vertex defines an arc (314). This arc intersects the arc (304) in FIG. 11 (see FIG. 13). Additionally, these arcs may have a second intersection in the region that lies behind the screen fixture (80). Typically, the second intersection is inconsequential, since the SONAR pinger is mounted on the screen 80 and radiates acoustic energy only in a ‘forward’ direction.

Triangle 320 is redundant but useful. The system can use it to estimate accuracy of the triangulation used for localization of object 201. To see the concept, visualize what happens when a hinge at line 313 is defined. If the hinge is flexed, the vertex where lines 312 and 321 meet will trace an arc that intersects the point where object 201 is located. In general, measurement errors will cause that arc to merely approach the point where object 201 is located rather than to actually intersect that point. The shortest distance between the arc and point 201 is a measure of the accuracy. It is possible to improve the accuracy of the localization by exploiting the redundancy taught above. Indeed, it is conventional practice in the art of ultrasound medical imaging to exploit such redundancy to greatly improve resolution of objects. Also, the system could have picked triangles 300, 320 or triangles 310, 320 rather than triangles 300, 310 to solve the localization problem. The fact that the system has redundant measurements allows for improved accuracy of localization.

Real-Time Performance Constraints

In some embodiments, it is desirable to achieve real-time localization information. If the system sends ultrasound wavelets sequentially at a rate equal to 30 Hz, it can achieve adequate performance for recognition of simple gestures. For example, moving a hand from right to left at 1 m/second for 30 cm should provide ˜10 sets of spatial coordinates with uncertainty less than 1 cm.

Concept of Gesture Recognition Volume (GRV)

The present discussion uses spherical coordinates as defined by ISO standard 33-11. This standard defines (r, θ, φ) where r is radial distance, θ is the inclination (or elevation), and φ is azimuth.

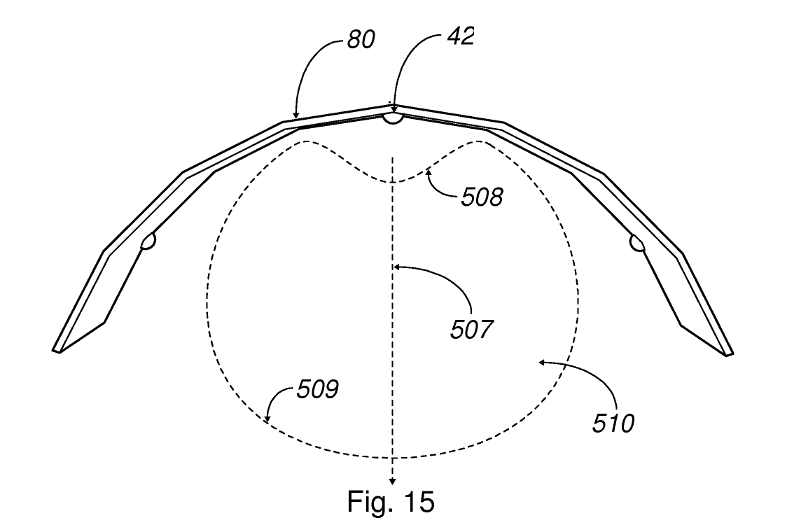

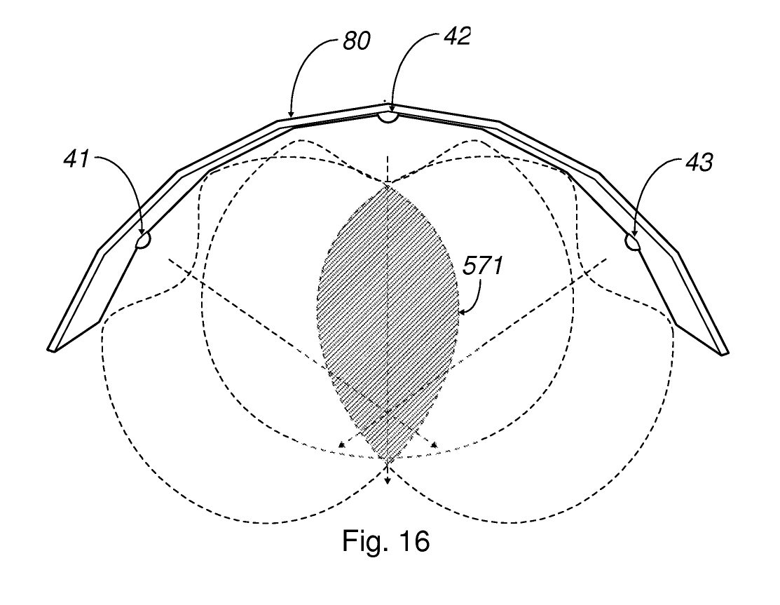

Sensitivity of SONAR devices follows approximately a cardioid pattern. FIG. 15 shows a pattern that has large beam width. As beam width is reduced, significant amounts of the radiated energy move to side lobes. Mitigation of the problems caused by such side lobes can add substantial complexity to prior-art ultrasound localization systems. A workaround to said problems, included in some embodiments, is to employ relatively wide beamwidths. Another embodiment provides an example of how the system can achieve accurate localization by means of receive-side beamforming.

The region of useful sensitivity is bounded by both a maximum range limitation and a minimum range limitation. Said maximum range limitation is a consequence of attenuation of the received reflection. The ultrasound signal disperses as it propagates with approximately an inverse-square-law behavior. At some point the received signal is not strong enough to produce a satisfactory signal-to-noise ratio so it becomes impossible to infer a valid measurement of the range.

In some embodiments, said minimum range limitation results from the following factors:

1. Excessively strong signals will overload the SONAR amplifier and give spurious results due to severe nonlinearity.

2. SONAR units cannot instantaneously switch from transmit to receive functionality. Mechanical ringing of the transducer persists for a short time following removal of the transmit excitation.

FIG. 15 shows the region of useful sensitivity for SONAR device 42 which is mounted in screen device 80. Line 507 is the axis of the SONAR unit. Lines 508 and 509 represent the surfaces that mark the minimum and maximum range limitations. Area 510 is the region of useful sensitivity for said SONAR device 42.

Adaptive Management of Gesture Recognition Volume (GRV)

In some embodiments, the system can deliberately modify the sensitive region seen by a single SONAR element. Consequently, the system can control, in real time, the actual size, volumetric shape, and location of the GRV. In particular, the GVR may be dynamically positioned such that it tracks object 201.

Said control gives the system the following additional capabilities:

1. Reduce GR computation burden by suppressing irrelevant inputs.

2. Improve signal-to-noise (SNR) data.

3. Improve power consumption by limiting amplitude of ultrasound pulses to that which is required by the current size of the GRV.

4. Improve speed of GRV by reducing duration of the timeslot allocated to each SONAR element.

Methods for effecting said control of sensitive region are as follows:

1. Ignore pulses whose TDOA exceeds a designated TDOA (max).

2. Reduce amplitude of ultrasound pulses.

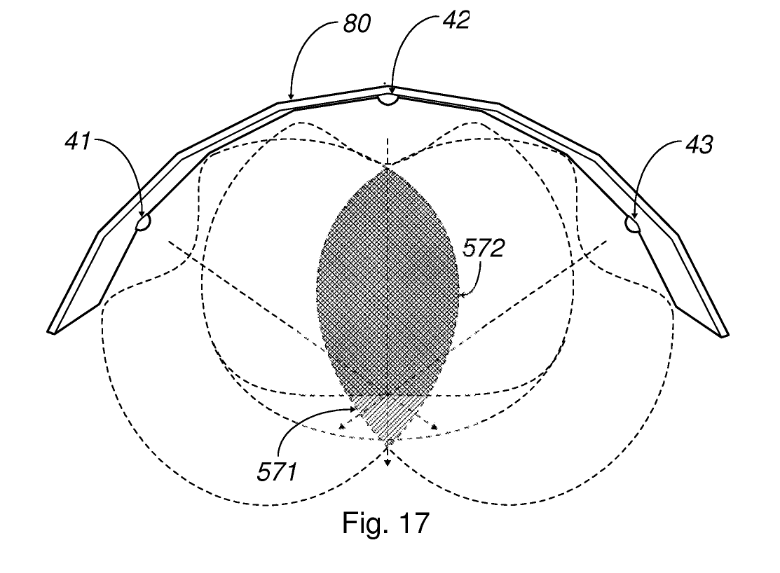

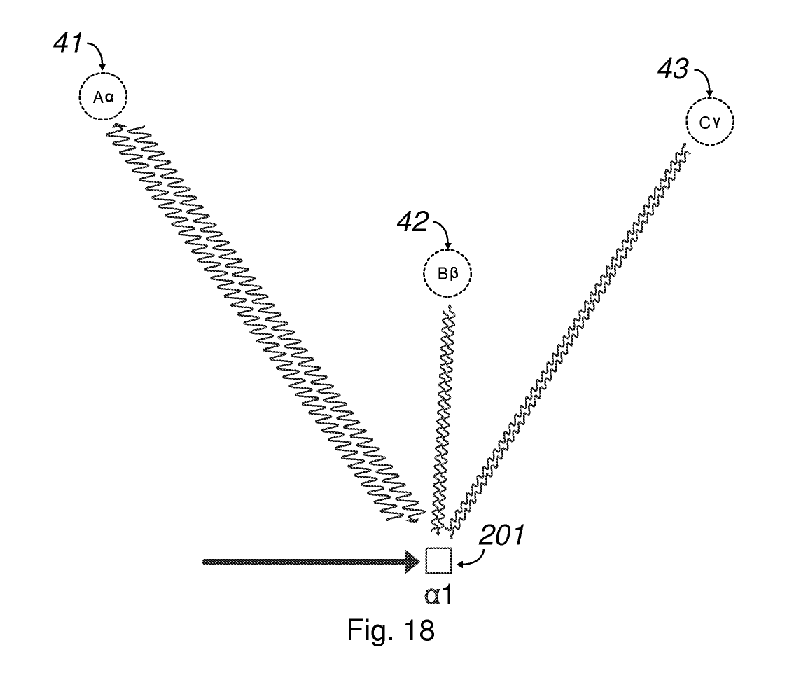

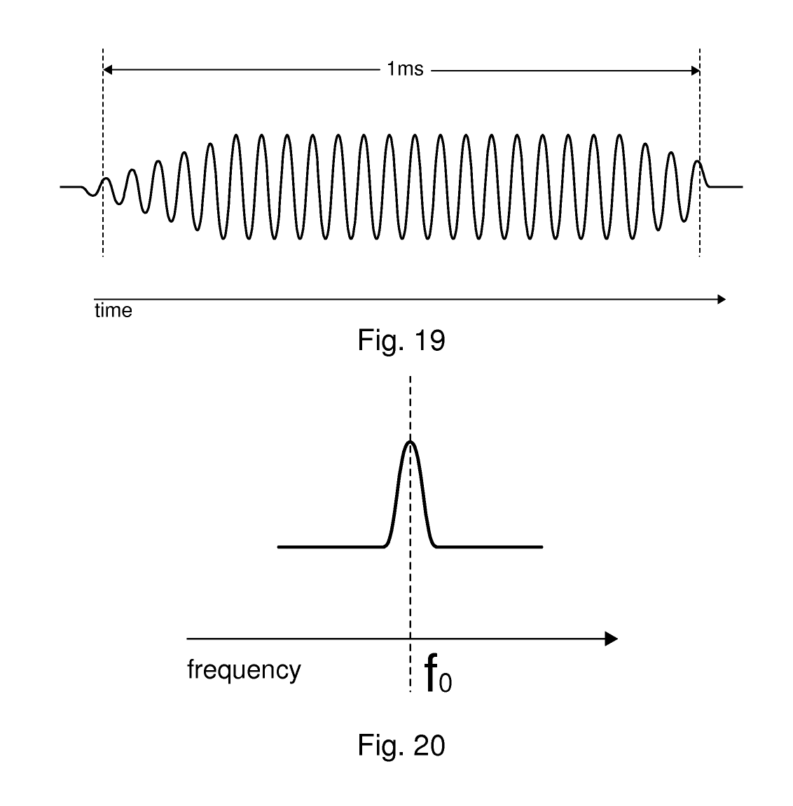

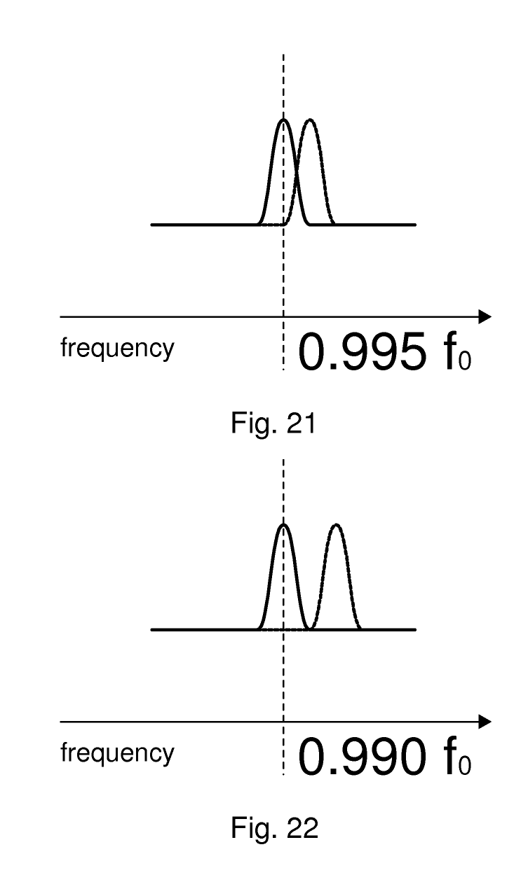

FIG. 17 shows that the system can change GRV from its nominal size as shown by cross-hatch-right shading 571 to a reduced size as shown by cross-hatch-left shading 572 by modifying amplitude or TDOA (max) of SONAR unit 42.

Concept of Sequentially Transmitting SONAR Pulses

If SONAR pulses are transmitted simultaneously or within an interval less than the TOA delay, disambiguation of echoes must be achieved. To eliminate the need for said disambiguation, in some embodiments pulses are transmitted sequentially.

Concept of Extracting Velocity Information from Sonar Pulses Reflected from Moving Object

If SONAR pulses are reflected by a moving object 201, then the frequency received by the receiver means within the SONAR unit may be Doppler-shifted. In general, the SONAR pulse can be viewed in either the time domain or the frequency domain. Consider an example where the pulse duration is one millisecond and the principle frequency component is 42 kHz. The Doppler principle states that the frequency-domain view of the reflected energy from said SONAR pulse will be shifted according to the speed of the object that causes reflection. If said speed relative to the SONAR unit is +/−1.7 meters per second, then the shift will be −/+1% of the 42 kHz principle frequency component. Consequently, the frequency of energy incident upon reflecting object 201 is 41.8 kHz (99.5%×42 kHz) and the frequency of reflected energy received by SONAR unit 41 is 41.6 kHz. To extract the velocity information the power spectrum of the reflected signal is calculated by running a Fast Fourier Transform (FFT) on the received time-domain signal, with a suitable window. In the following equation

v_norm=v_sound*delta_{—}f/fo/2

v_norm==velocity of the object in the direction normal to the axis of the relevant sensor,

v_sound==speed of sound,

fo==principle frequency of excitation generated by Sonar unit 41, and

delta_f==frequency extracted from FFT analysis.

Concept of Device Area Network (DAN)

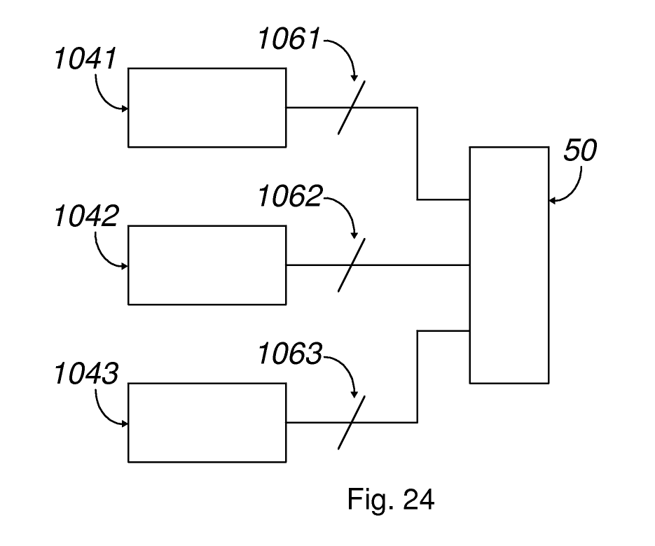

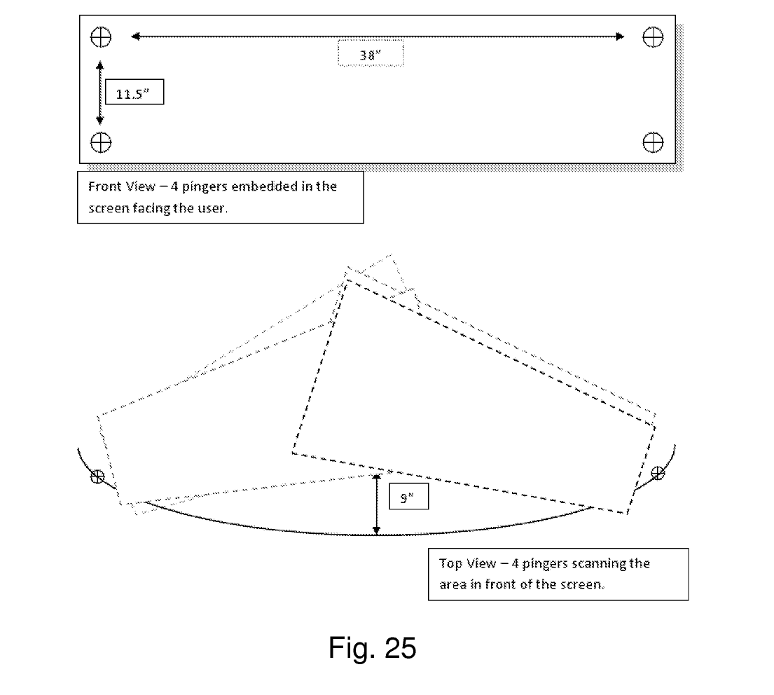

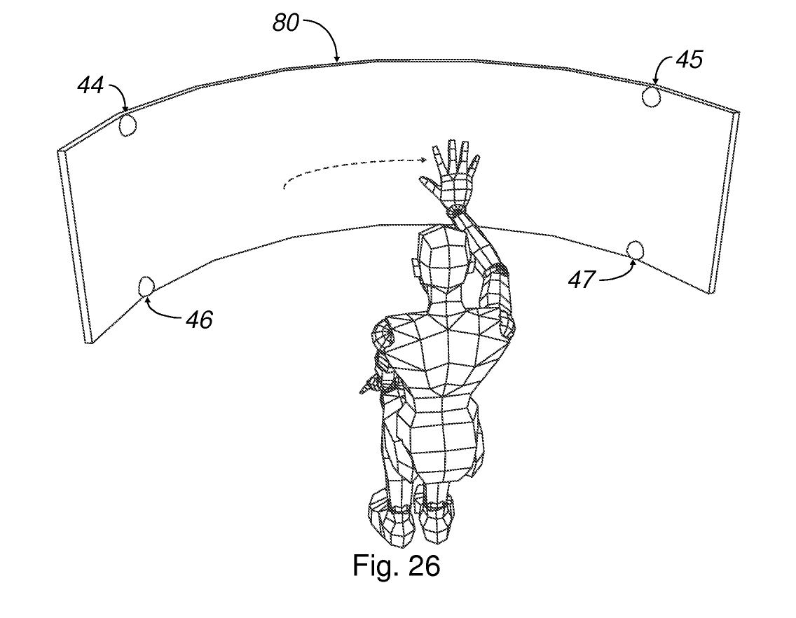

The first embodiment has a plurality of devices incorporated within a DAN. FIG. 3 shows a DAN which has only a single device. FIG. 24 shows that element 50 can be generalized such that it is a hub that aggregates signals from a plurality of devices. The hub shown in FIG. 24 can support the three SONAR units which comprise the DAN within the system shown in FIG. 2.

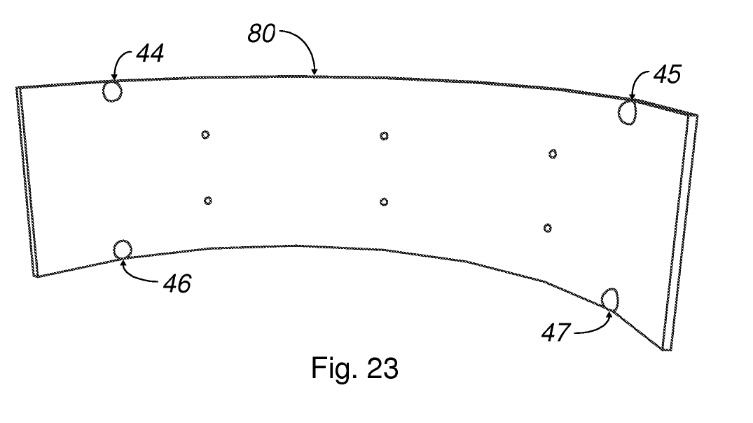

A second embodiment is described with reference to FIG. 23. Except for the fact that this second embodiment contains four SONAR units rather than three, it is similar to the first embodiment. Benefits that accrue from using more than three SONAR units are as follows:
1. Self-test of accuracy of each SONAR unit is possible. Accuracy of SONAR measurement from any unit can be assessed in real time by comparing the range measured by that SONAR unit with the range inferred from analysis of measurements produced by the (n−1) other SONAR units.

2. Aggregate size of gesture recognition volume (GRV) can be increased. The GRV consists of the spatial region in which at least three SONAR units can see the gesture.

3. Power versus accuracy tradeoff of GRS can be managed in response to user's presence and location. While a user is absent, it is necessary to power one or more SONAR units only during the short and infrequent intervals required for determining when a user arrives.

4. The system gains accuracy because redundant information gained by the fact that it can triangulate between a plurality of sets of SONAR units allows it to use statistical analysis to improve measurement accuracy.

Physical Verification of the Performance of Second Embodiment

Hardware used for this experiment has been described elsewhere herein and illustrated in FIG. 3. In the tabulated data below, the first column shows the time elapsed since the last update from the FPGA controlling the pingers. Each range column represents a pinger's range to the target. The asterisk indicates the reading is within the gesture area. The system takes the best 3 out of 4 reports to determine the gesture. In a larger plane with more pingers multiple independent targets can be easily tracked using this localized but transient clump-report.

| Time | Range 1 | | Range 2 | | Range 3 | | Range 4 | |
|---|---|---|---|---|---|---|---|---|
| 0.068 s | 259.9 | cm | 32.4 | cm* | 72.6 | cm* | 33.4 | cm* |
| 0.068 s | 68.4 | cm* | 32.4 | cm* | 72.6 | cm* | 33.4 | cm* |
| 0.068 s | 68.4 | cm* | 25.3 | cm* | 72.6 | cm* | 33.4 | cm* |
| 0.069 s | 68.4 | cm* | 25.3 | cm* | 66.7 | cm* | 33.4 | cm* |
| 0.068 s | 68.4 | cm* | 25.3 | cm* | 66.7 | cm* | 36.5 | cm* |
| 0.068 s | 69.4 | cm* | 25.3 | cm* | 66.7 | cm* | 36.5 | cm* |
| 0.068 s | 69.4 | cm* | 35.4 | cm* | 66.7 | cm* | 36.5 | cm* |
| 0.068 s | 69.4 | cm* | 35.4 | cm* | 124.9 | cm | 36.5 | cm* |
| 0.068 s | 69.4 | cm* | 35.4 | cm* | 124.9 | cm | 53.5 | cm* |
| 0.068 s | 53.4 | cm* | 35.4 | cm* | 124.9 | cm | 53.5 | cm* |
| 0.068 s | 53.4 | cm* | 46.4 | cm* | 124.9 | cm | 53.5 | cm* |
| 0.068 s | 53.4 | cm* | 46.4 | cm* | 52.4 | cm* | 53.5 | cm* |
| 0.068 s | 53.4 | cm* | 46.4 | cm* | 52.4 | cm* | 54.5 | cm* |
| 0.068 s | 34.4 | cm* | 46.4 | cm* | 52.4 | cm* | 54.5 | cm* |
| 0.068 s | 34.4 | cm* | 56.6 | cm* | 52.4 | cm* | 54.5 | cm* |
| 0.068 s | 34.4 | cm* | 56.6 | cm* | 123.9 | cm | 54.5 | cm* |
| 0.068 s | 34.4 | cm* | 56.6 | cm* | 123.9 | cm | 69.7 | cm* |
| 0.068 s | 22.3 | cm* | 56.6 | cm* | 123.9 | cm | 69.7 | cm* |
| 0.068 s | 22.3 | cm* | 65.6 | cm* | 123.9 | cm | 69.7 | cm* |
| 0.068 s | 22.3 | cm* | 65.6 | cm* | 123.8 | cm | 69.7 | cm* |
| 0.068 s | 22.3 | cm* | 65.6 | cm* | 123.8 | cm | 64.6 | cm* |
| 0.068 s | 18.3 | cm | 65.6 | cm* | 123.8 | cm | 64.6 | cm* |
| 0.069 s | 18.3 | cm | 66.6 | cm* | 123.8 | cm | 64.6 | cm* |
| 0.068 s | 18.3 | cm | 66.6 | cm* | 124.9 | cm | 64.6 | cm* |
| 0.068 s | 18.3 | cm | 66.6 | cm* | 124.9 | cm | 64.5 | cm* |
| 0.067 s | 21.2 | cm | 66.6 | cm* | 124.9 | cm | 64.5 | cm* |
| 0.068 s | 21.2 | cm | 62.5 | cm* | 124.9 | cm | 64.5 | cm* |
| 0.068 s | 21.2 | cm | 62.5 | cm* | 102.8 | cm* | 64.5 | cm* |
| 0.068 s | 21.2 | cm | 62.5 | cm* | 102.8 | cm* | 60.6 | cm* |
| 0.068 s | 35.4 | cm* | 62.5 | cm* | 102.8 | cm* | 60.6 | cm* |
| 0.068 s | 35.4 | cm* | 49.4 | cm* | 102.8 | cm* | 60.6 | cm* |
| 0.068 s | 35.4 | cm* | 49.4 | cm* | 53.5 | cm* | 60.6 | cm* |
| 0.068 s | 35.4 | cm* | 49.4 | cm* | 53.5 | cm* | 48.5 | cm* |
| 0.068 s | 56.4 | cm* | 49.4 | cm* | 53.5 | cm* | 48.5 | cm* |
| 0.068 s | 56.4 | cm* | 39.4 | cm* | 53.5 | cm* | 48.5 | cm* |
| 0.068 s | 56.4 | cm* | 39.4 | cm* | 62.6 | cm* | 48.5 | cm* |
| 0.068 s | 56.4 | cm* | 39.4 | cm* | 62.6 | cm* | 37.4 | cm* |

The demo activates the pingers in succession in order to prevent reading another pinger's ping by mistake. This method prevents the system from reading many more ranges at a faster rate. If one emitter was illuminating the target while multiple receivers listened, the system can increase both the rate at which ranges are read and the number of ranges read. This allows for more resolution and multiple or distributed targets.

Various embodiments include a Graphical User Interface (GUI) configured to facilitate collection and analysis of data. The GUI presents the position and range information in real time, as the data is received from the pingers. It shows the “best 3” clump used to track a target's movement. From this data the system infers gestures which in turn trigger responses, such as switching a hardware function on or off.

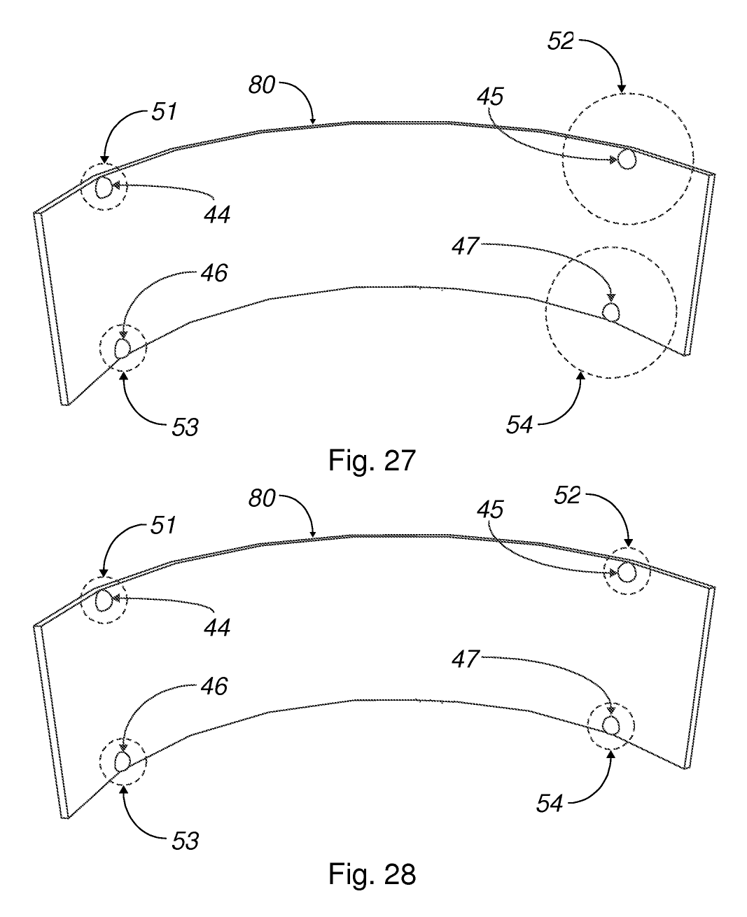

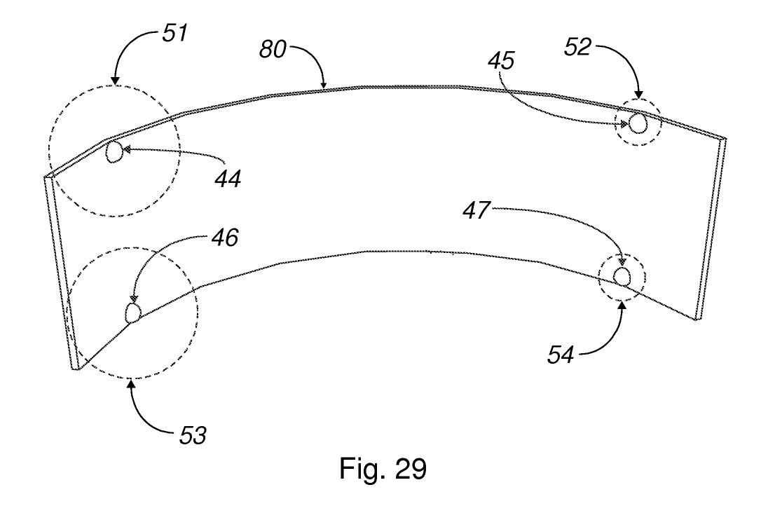

With reference to FIG. 27, for example, the diameter of each circle 51, 52, 53, 54 is proportional to the distance between the SONAR element at its origin and the object (human hand) being tracked.

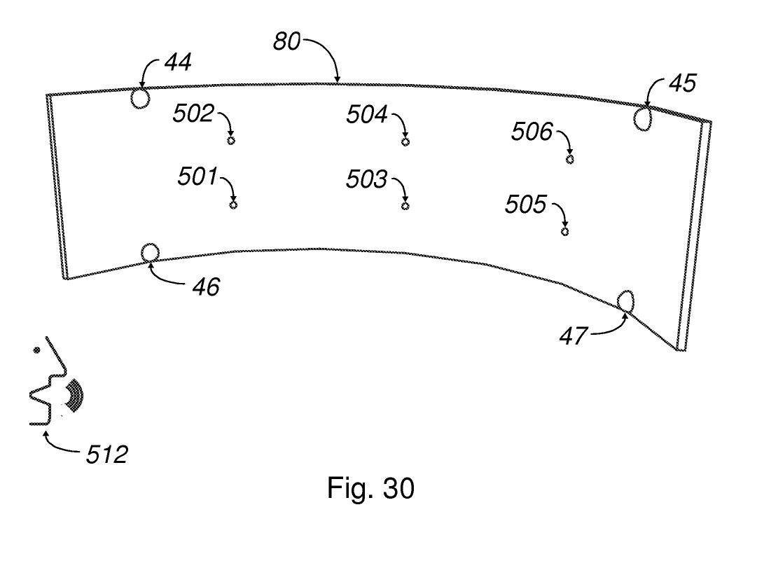

A third embodiment is described with reference to FIG. 30. This embodiment of the present invention optionally includes all of the elements contained in the first embodiment, plus a phase coherent array microphone (PCAM) comprised of microphone devices 501, 502, . . . , 506. Information gleaned from the output of the PCAM complements information gleaned from the SONAR units. By means of Bayesian fusion the system can advantageously combine information learned by SONAR localization with information learned by time-of-arrival (TOA) analysis of the audio signal gathered by the PCAM. Localization techniques that use the speaker's utterances to localize his position exist within the prior art.

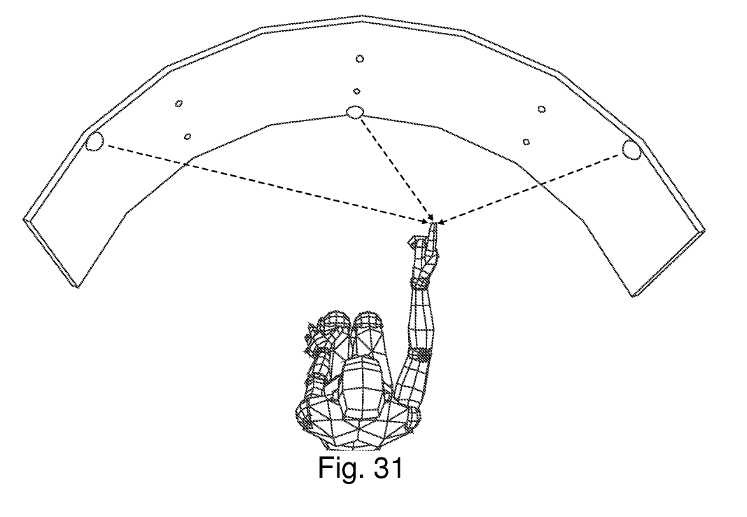

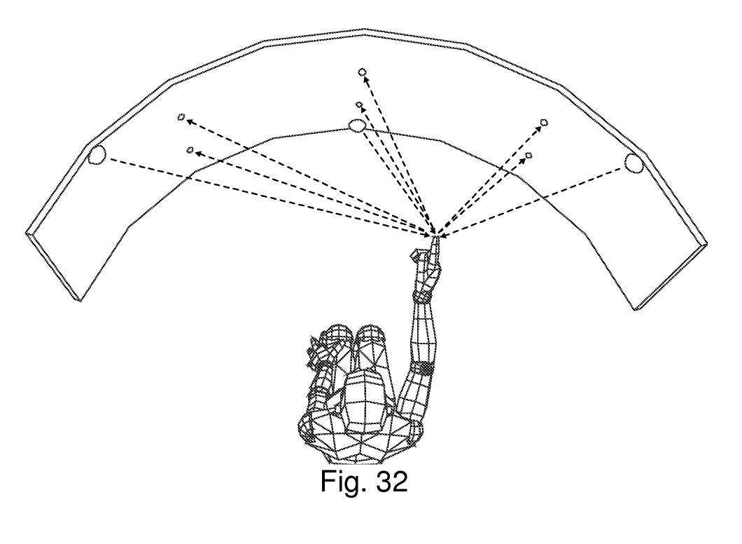

A fourth embodiment is described with reference to FIGS. 30-32 and differs from the third embodiment as follows. The system uses microphone elements at locations 501-506 to detect ultrasonic illumination provided by ultrasound emitters within the SONAR units 41, 42, 43. Said ultrasound emitters sequentially illuminate all objects (including user's fingertip) within the Gesture Recognition Volume (GRV) as shown in FIG. 31. Ultrasonic energy is reflected by user's fingertip and all other objects within GRV. The system collects TDOA data from each microphone element and from each of the acoustic receivers within the array of SONAR transducers. The acoustic receivers embedded within the SONAR elements are functionally similar to the microphones. Both are acoustic sense elements. The system then performs image analysis upon the set of all data collected from the acoustic sense elements. Because the system is collecting data from a larger set of acoustic sense elements, the system is able to reduce the uncertainty of the exact location of each point within the set of surfaces that are reflecting acoustic energy.

Accurate Timing Means

In some embodiments, an accurate timing system provides a local clock where analog-to-digital conversion (ADC) is performed for any given microphone element. Said timing system allows sampling and ADC to be synchronous relative to generation of ultrasonic illumination. Said timing system typically has aggregate tolerance that corresponds to a path-length delay that is much smaller than the dimension of the smallest object being imaged. As a guideline, timing tolerance that corresponds to 5% of the wavelength of the ultrasonic illumination can be allocated. With 100 kHz ultrasonic illumination, said tolerance is about 400 nanoseconds.

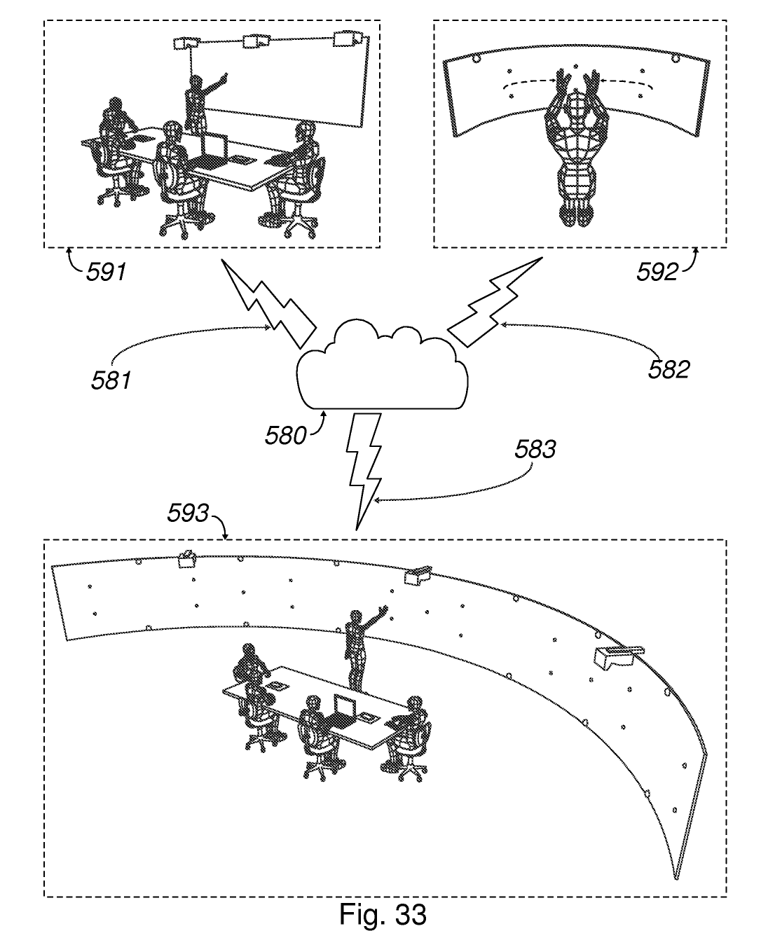

FIGS. 33 through 36 describe a fifth embodiment. In addition to the features described with respect to the fourth embodiment, the fifth embodiment optionally also includes the following:
Incorporate loudspeaker systems and methods within the IMT
   use WFS to achieve spatial fidelity
   use echo cancellation
   improve echo-cancellation performance by novel means
Incorporate a video display within the IMT
   use short-throw front-side-projection elements capable of displaying either 2D or stereographic 3D images
   incorporate super-resolution means within the display
Incorporate User Permission Means (UPM), Control Means (CTRL) and Arbitration Means (ARB)
Incorporate device area network (DAN) within the IMT
   to distribute an accurate clock to all elements within the IMT
   to facilitate discovery of external compatible devices and to allow them to bond with the IMT by securely joining the DAN
   to distribute an accurate clock to external compatible devices which have joined the DAN
   Integrate Ultra Wide Band (UWB) RFID and ranging within DAN
Use TX devices as the sole source of ultrasonic illumination.
Integrate camera elements within or near the display screen of the IMT
   to solve the gaze-angle problem for telepresence communication
   to capture real-time stereographic images of users or things within the gesture recognition volume
   to capture images which can be transformed into free-viewpoint 2D or stereoscopic images of things or people within the telepresence volume
Integrate gesture recognition capability
   as a means of allowing users to control IMTs
   as a means of allowing users to convey information
   as a means of drawing things on the display of the IMT
Integrate voice recognition capability
   as a means of allowing users to control IMTs
   as a means of allowing users to control other things
   as a means of allowing users to generate or modify graphic or video information which is shown on local or remote display screens
Integrate windows-management capability on the display
   as a means of allowing users to conveniently switch between a plurality of layers of information captured on multiple pages of the display
   as a means for allowing one or more pages of said display to be captured into a memory means
Incorporate network capability as a means for allowing a plurality of IMTs to participate in a Telepresence Communication Session

It is advantageous to integrate loudspeaker system within the IMT.

Use Wavefield Synthesis (WFS) to achieve spatial fidelity

In ordinary human interactions that involve no telephony or other technology, significant information is conveyed within the spatial details of the soundfield. It is advantageous to use WFS so that such information can be captured and conveyed by the IMT.

Use Echo Cancellation

The problem of managing audio feedback in applications where speakers and microphones are present has been studied. It will be clear to those skilled in the art that echo cancellation techniques may used within the signal processing chain of the IMT. Prior art systems are unable to combine good surround sound performance with satisfactory echo cancellation performance. The unfortunate result of this tradeoff is that telephone and telepresence systems sacrifice good spatial sound performance in order to avoid the effects of inadequate echo cancellation performance.

Improved Echo-Cancellation Performance

A novel and advantageous way to improve said tradeoff is included in some embodiments. Here, t system uses beamforming as a means of rejecting much of the sound that comes from the loudspeaker system. Beamforming focuses on the speaker (604, 605, . . . 608), thereby significantly increasing the amplitude of his voice relative to the amplitude of the sound coming from the loudspeaker.

Incorporation of a Video Display within the IMT

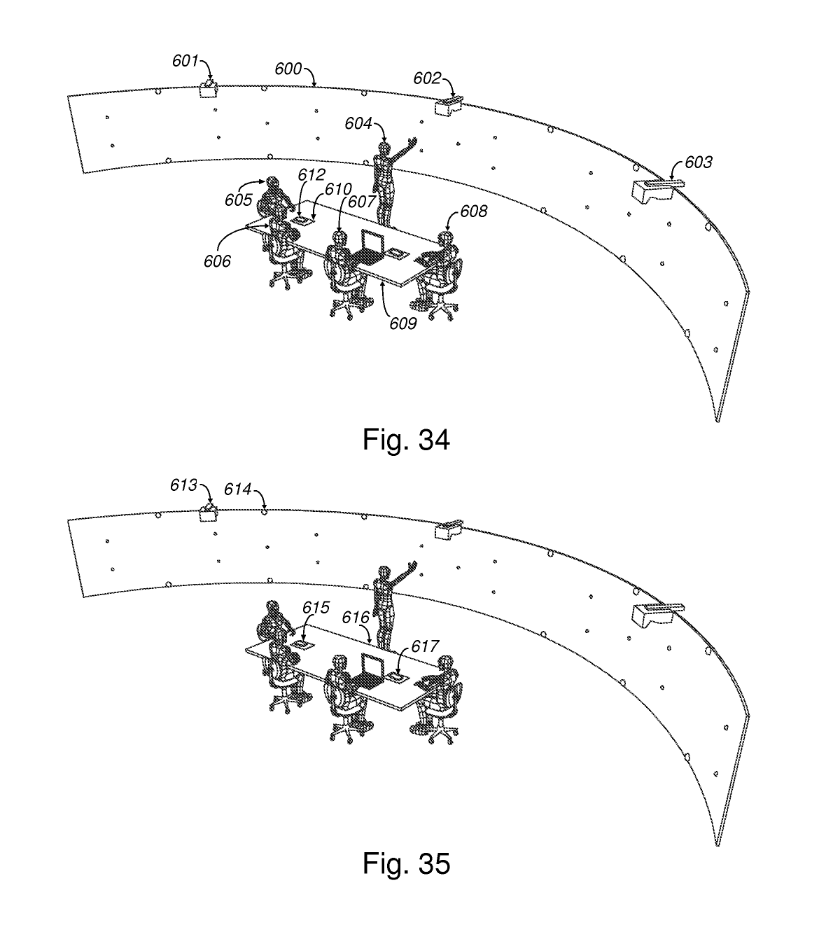

Considering IMT 593 shown in FIG. 33, screen fixture 600 (FIG. 34) can be used as the display screen of a front-side projection display.

Use Short-Throw Front-Side-Projection Elements Capable of Displaying Either 2D or Stereographic 3D Images

Said front-side projection display can use one or more projection elements to generate either a 2D or a stereographic 3D image. FIG. 34 shows a specific example where the display screen is about six feet high and about twenty feet wide, with a radius of curvature of about forty feet. Three projection elements 601, 602, 603 are used.

Incorporate Super-Resolution Means within the Display

U.S. Pat. No. 6,456,339, entitled “Super-Resolution Display,” teaches a means of achieving super-resolution and is incorporated herein by reference. Said super-resolution is achieved when the resolution of the display is substantially higher than any one of a plurality of projectors used to generate said display. Said patent requires a camera means to provide feedback for pixel-correction means. Advantageously, said feedback can be provided by means of cameras that are discovered and connected by the Device Area Network (DAN) embedded within the IMT.

Incorporation of User-Permission-Means (UPM), Control Means (CTRL) and Arbitration Means (ARB) within the IMT

UPM

Password-control is one of several user-permission-methods. In some embodiments, when the IMT system is first shipped to an end customer, it can be powered up by simply turning its power switch on. It boots and displays a screen that allows a user to set a password or a password-equivalent. The set of password-equivalents is a function of the optional resources that have been built into the specific IMT. For example, the password-equivalent could be a fingerprint if the IMT is equipped with a fingerprint reader, or an RFID tag if the IMT is equipped to read RFID tags, or a string of characters on a keyboard if the IMT is equipped with a keyboard. Once the password-equivalent has been set, the UPM allows authorized users to set accounts for any quantity of privileged users. Users without any special privilege will be called ‘general users’ in this discussion. Users with the highest level of privilege will be called ‘root’. Any ‘root’ user is allowed to modify any setting of the Control Means.

CTRL

In typical embodiments, the IMT is controlled by an embedded computer. Once the UPM has been set up, the IMT retains information using nonvolatile memory even if its power is turned off. Nonvolatile memory such as NAND-flash chips or hard drive is used in the Control system. Said memory forms a nonvolatile register that allows the Control System to achieve retention of UPM information and initialization information.

When IMT power is cycled, the IMT is configured to reboot. Upon reboot it enters a state that is retained within said nonvolatile register. Said state allows at least one system configured for receiving commands. Said system is optionally based on gesture recognition. Thus it is possible for the IMT to recognize a gesture that wakes up the IMT, thereby causing it to become more fully functional. The simplest among said gestures is simple presence. In other words, a given IMT is optionally programmed to become fully functional when a user just shows up.

ARB

In some embodiments, there is a possibility that the IMT will receive multiple commands that are not consistent. To resolve said inconsistency, the IMT has an arbitration system. UPM and CTRL allow establishment of different levels of privilege. If there are multiple users sharing a given level of privilege, or a lack of privilege, the relative priority of said group of users is established by any criterion set by a root user. This criterion can be set to simple seniority (within a set of users whose privilege level is identical, priority is allocated so that the ‘oldest’ user has highest priority).

Incorporation of Device Area Network (DAN) within the IMT

As taught in the fourth embodiment, it is advantageous to use a timing means that establishes a clock of sufficiently quality to allow the spatially-distributed acoustic sensors to serve as a phase-coherent microphone array. The timing means are incorporated and distributed within the Device Area Network (DAN). Said DAN is optionally built with a hub-and-spoke network which allows each element of the DAN to directly connect with a central aggregator within the IMT. By configuring a hard-wired dedicated connection to carry all data to and from each element within the IMT it is typically possible to substantially eliminate contention and latency within the transport layer. The disadvantage of this approach is the fact that it requires more wires and more connection overhead than a hierarchical network that uses packet-switching means. Prior-art network communication means such as USB2 and Ethernet use hierarchical packet-switching methods to achieve good economy. This economy is offset by the hidden cost of indeterminate delay within the data-transport layer. In some embodiments the economical advantage of hierarchical packet-switched connection is achieved while retaining the advantages of determinate delay by using a novel network structure, with the description immediately below.

To Distribute an Accurate Clock to all Elements within the IMT

“Accurate clock” is defined as a clock with the following characteristics:

Jitter is sufficiently low to ensure that clock can be directly used for analog-to-digital conversion of acoustic signals, without contributing significant degradation to the spurious-free dynamic range (SFDR).

Absolute time relative to the master clock means is known and is fully determinate.

The DAN can use wired or wireless means, and it may be structured hierarchically with intermediate hubs, as long as the characteristics listed above are retained.

To facilitate discovery of external compatible devices and to allow them to bond with the IMT by securely joining the DAN

External compatible devices with wired USB3 connections can be joined to the network by monitoring termination impedance at their electrical connection points. Methods for said monitoring are taught in the USB3 specification published by the USBIF group. RFID tags within external compatible devices facilitate confirmation of their security status.

To an distribute accurate clock to external compatible devices which have joined the DAN

The TX lane of wired USB3 connections distributed to external compatible devices can be used to distribute the clockclock.

Integrate UWB Ranging and RFID within DAN

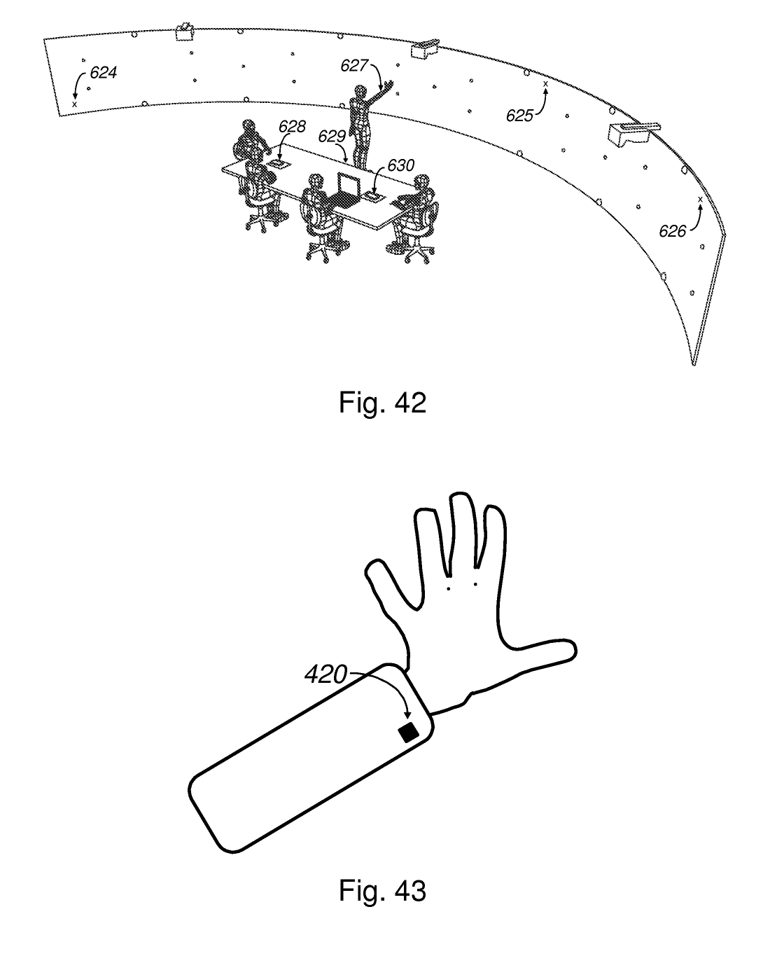

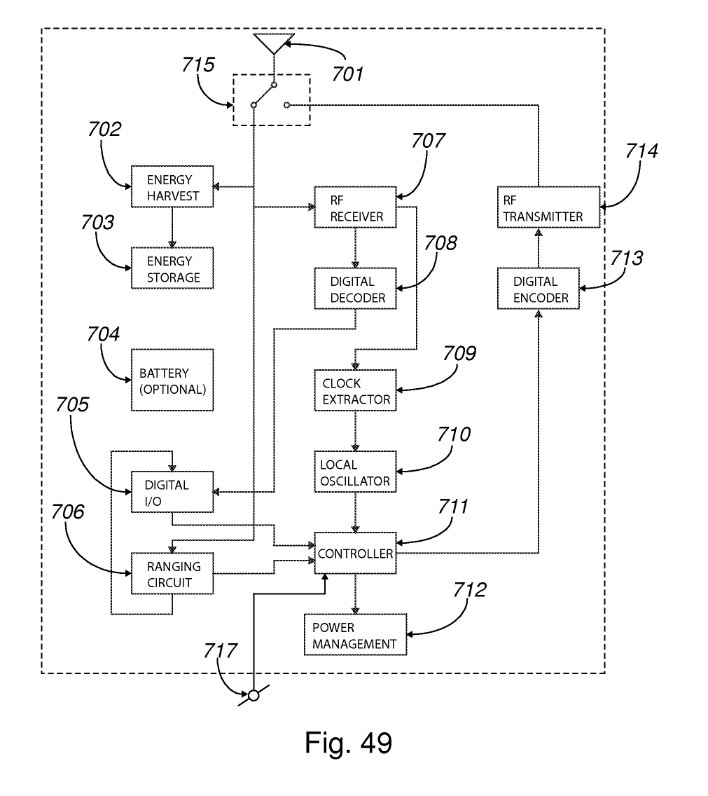

As shown by FIG. 42, it can be advantageous to use UWB ranging and RFID as a means of discovering and tracking external compatible devices. FIG. 49 shows a block diagram of a typical RFID chip.

In order to eliminate substantial redundancy and cost, said Ranging and RFID systems are optionally integrated within the wireless transceiver system integral within DAN. FIGS. 42 and 43 show that the RFID chips themselves can comprise external compatible devices.

Selection of optimal frequency band is an additional consideration.

In some embodiments technology cost parameters which vary from year to year are important optimization factors. Although most prior-art systems are implemented in frequency bands below 10 GHz, it is likely that 60 GHz will prove to have substantially better cost and performance at high production volumes. Optimization involves choice of both TX and RX bands. For applications such as cell phones, it is well known that TX/RX isolation can be improved by use of substantially different frequencies. For RFID applications, it is advantageous to radiate the energy to be harvested for RFID and ranging operation at frequencies substantially different from the frequency radiated by the RFID tag. For example, we can radiate the power signal at a frequency below 10 GHz and then use a frequency in the 60 GHz band for radiation of the RFID and ranging signal.

In some embodiments, antenna parameters are important optimization considerations. It is novel and advantageous to implement the antenna by means of wirebonds placed within the package containing the RFID device. Key advantages thereby achieved become clear when the entire chip-package-antenna system is simulated using a fast field solver. Specifically, the role of the chip substrate in absorbing RF energy can be minimized by placement of the radiating element about a hundred microns above the surface of the chip. Said placement becomes relatively simple and inexpensive when a wire bond comprises said element. Said placement becomes relatively more predictable when said element is implemented with a copper wirebond rather than a gold wirebond. The reason for said improved predictability is the reduced displacement caused by the fact that copper is relatively more stiff than gold during the formation of integrated circuit packages such as the Unisem ELP or the Mitsui-High-Tec HMT.

In some embodiments, loss-tangent of the resin that serves as dielectric within said packages is also an important optimization consideration. In general, little is publicly known about the loss-tangent behavior and production tolerance, since these factors are rarely important when said packages are used in prior-art applications. This application teaches that performance of said packages at microwave frequencies exceeding 1 GHz can be improved by using resin which has been designed to exhibit low loss tangent in the frequency bands of interest.

Use TX Devices as the Sole Source of Ultrasonic Illumination

Whereas the fourth embodiment taught an ultrasonic imaging method that used SONAR units at 41, 42, 43, 44, the fifth embodiment uses units that just transmit ultrasound energy. These units are referred to as ‘TX devices’. It is advantageous to use TX devices which emit radiation patterns with wide-beam-width (nearly omnidirectional). Benefits include:
1. side lobes will be nearly eliminated.
2. physical size of said TX devices can be small (on the order of 2 mm) so that they can be embedded within the screen.
3. The IMT optionally includes a relatively large number of said TX units and excite them in the manner which achieves the best tradeoff of image resolution, GRV size and location, recognition speed, and power dissipation.

Said TX devices are optionally included within the IMT or within external compatible devices that join the IMT by means of a connection facilitated by the DAN.

Referring to FIG. 35, TX devices have been embedded within a plurality of things, at locations 613-617. At location 613, TX device is within a short-throw projection display device. At location 614, TX device is within the display screen. At locations 615 and 617, TX devices are within external compatible cellphones that have been discovered and joined to the IMT. At location 616, TX device is within a table that has been discovered and joined to the IMT.

Integrate Camera Elements within or Near the Display Screen of the IMT

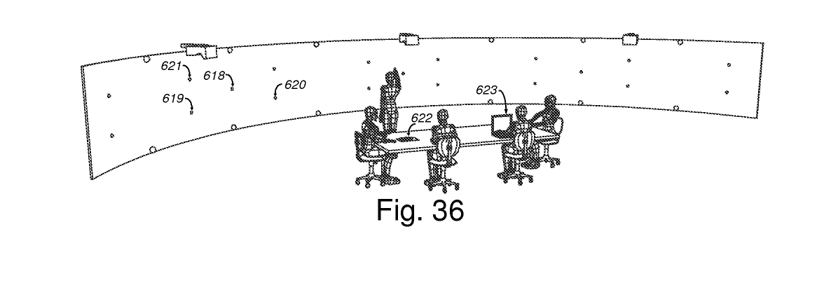

FIG. 36 shows that numerous cameras have been embedded within the IMT or external compatible devices. Cameras at locations 618-621 have been embedded within the screen of the IMT display. Said cameras generate images without gaze-angle problems. Camera 622 is a camera integral within a cellphone. Camera 623 is a camera integral within a laptop. The cellphone and the laptop are external compatible devices that have been discovered and joined to the IMT by means of the DAN.

It is advantageous to create telepresence resources consisting of a virtual 3D camera and a virtual 3D microphone. Said resources can be deployed under machine control in real time so that the remote parties can see and listen to the person or object of their current interest. Said machine control can be asserted by person who is local or at a remote terminal, or by a control means such as a computer running a resource-control algorithm.
In some embodiments gesture recognition capability is integrated in the IMT
as a system for allowing users to control IMTs
as a system for allowing users to convey information
as a system for drawing things on the display of the IMT.

In some embodiments voice recognition capability is integrated in the IMT
as a system for allowing users to control IMTs
as a system for allowing users to control other things
as a system for allowing users to generate or modify graphic or video information which is shown on local or remote display screens.

In Some Embodiments Windows-Management Capability on the Display is Integrated in the IMT
as a system for allowing users to conveniently switch between a plurality of layers of information captured on multiple pages of the display.

In some embodiments, corporate network capability is configured to allow a plurality of IMTs to participate in a Telepresence Communication Session.

Referring to FIG. 33, elements 580-583 comprise a network connection means which allows a plurality of IMTs to participate in a telepresence communication session.

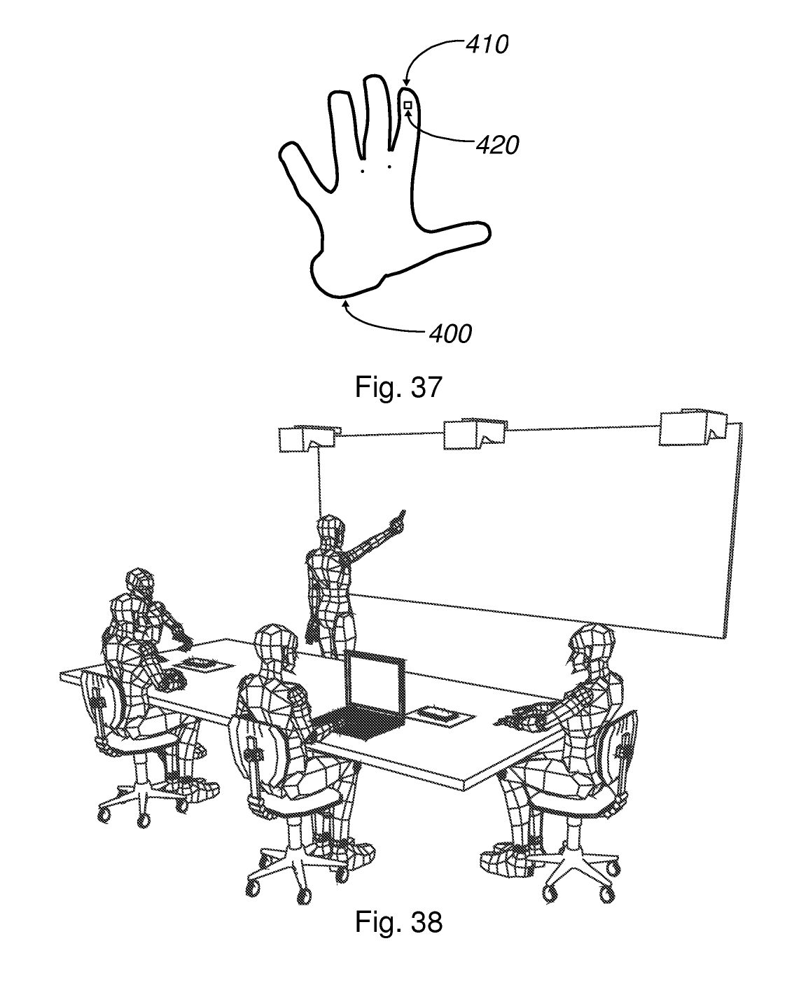

A sixth embodiment is illustrated with respect to FIG. 37. A radio frequency identification chip (RFID) is configured to facilitate disambiguation and to securely convey identification, password, and authorization. Workplace usage of these features is documented in the following sections of the present application, among others:

Use-case scenario 3.1—Information Technology system admin (sysadmin)

Use-case scenario 3.2—surgeon

Use-case scenario 3.3—bank clerk

Use-case scenario 5.1—store clerk

There may be multiple objects (like hands) in the designated Gesture Recognition Volume (GRV). Some embodiments include an embedded RFID chip (420) in the finger (410) of the surgeon's glove (400) or other clothing. For example, FIG. 43 illustrates how an RFID chip can be embedded in the sleeve of a bank teller or store clerk.

To minimize cost and facilitate serialization, an RFID chip that does not require any external connections can be used. Power for the RFID chip can come from harvesting energy with on-chip energy conversion circuits. Alternatively, the RFID chip can be powered by a tiny battery. Operating frequencies can be selected that allow the GRS to infer localization to an accuracy of about three centimeters. RF transceivers capable of powering the remote RFID chips (in the surgeon's glove) can be embedded in the display screen, and triangulation of TOA data can be used for localization of the glove. FIG. 49 is a block diagram of a typical RFID device. FIG. 42 shows how RFID reader devices can be embedded within the IMT or any device which joins the DAN.

A seventh embodiment of the present invention teaches a means of multimedia communication. With reference to FIG. 38, a user can employ the apparatus and methods taught in other sections of this specification to draw on an electronic whiteboard. Prior-art electronic chalkboard apparatus employ markers to actually paint the information on a screen. The markers are expensive and messy and cause the whiteboard to wear out. Also, said prior-art inventions are incapable of mixing electronic images or video information with hand-drawn sketches.

In some embodiments, the invention taught here uses the 3D gesture-recognition capability as an advantageous means of sketching information that is painted on the display by means of the projection apparatus. This apparatus is preferably a short-throw frontside projector. The user can ‘draw’ by just moving his fingertip in the air. Operating mode and parameters are set by means of gesture recognition, voice recognition, instantiation of command profiles, or use of conventional HCI devices such as keyboard and mouse. The user interface allows the specific user to choose whichever of these modes of control he prefers.

Advantageously, these embodiments allow the user to present information that is available in other forms. For example, the user can make a gesture that defines a box into which a 3D video sequence will be displayed. Alternatively, the user can use voice recognition as an HCI modality that commands the IMT to display said 3D video sequence. The user can write on the board by using voice recognition to transcribe speech into words that are displayed on the board. The user can invoke optical character recognition to turn cursive finger-painting into Helvetica text, as a further example.

Optionally, the 3D display means can create the image of a plane in free space. This image can be thought of as a virtual plane. Because the user can see this virtual plane with his eyes, the user can ‘touch’ it with his fingertip. Said touching allows the user to easily draw in two dimensions. The user can control drawing parameters like line width by pushing the drawing finger through the virtual plane. Alternatively, the user can set control parameters so that a set of images of planes is displayed in different colors. As another example, the user can draw in the desired color by ‘touching’ the color-coded plane while tracing a line.

An eighth embodiment provides systems and methods of using gesture recognition to improve performance of speech recognition systems. The components of this system further include:

spatially distributed phase coherent microphone array, as described in the third embodiment items 501-506,

aggregation means, as described in the DAN of the fifth embodiment,

means for beam forming, as described in the DAN of the fifth embodiment, and

one or more TX devices for emitting an ultrasound signal, as described above in the fifth embodiment regarding items 41, 42, and 43.

Gestures can be used to invoke speech recognition during the actual utterances that are to be recognized. As a single-user example, a user is driving a car having a radio. The user points to the radio and says “what is the weather in Tulsa next week”. The radio responds with the requested weather report. The radio uses the gesture to determine that the audio signal is intended to be a command for the radio and processes the audio signal accordingly.

This method is advantageous for the following reasons.
1. The speech-recognition means is able to run at lower power because it need not be powered up until the invocation gesture has been detected.
2. The speech-recognition engine can deliver better recognition performance because it is not subject to as many irrelevant or noisy inputs.
3. The user interface is faster, simplified, and costs reduced by eliminating the step of pressing a button to begin the speech-recognition engine.
4. Optionally, the user can utter a training word while continuing to point to the radio. The training word can be used to set speaker-localization and noise-rejection parameters of the algorithm used for beamforming of the speaker's voice during the subsequent voice-recognition interval.
5. Optionally, the user can utter words while continuing to point to the radio. Said additional words can be part of the gesture.

The example given above can be generalized as follows:

Example: A car has one driver and three passengers. All four persons are users. The users in the back seat can use display terminals embedded in the back of each front seat. Each display terminal has a control resource consisting of a PCAM and a TX device for gesture recognition. Either of said back-seat users can point to his terminal and command it by voice recognition as described in the single-user example given above.

Microphone

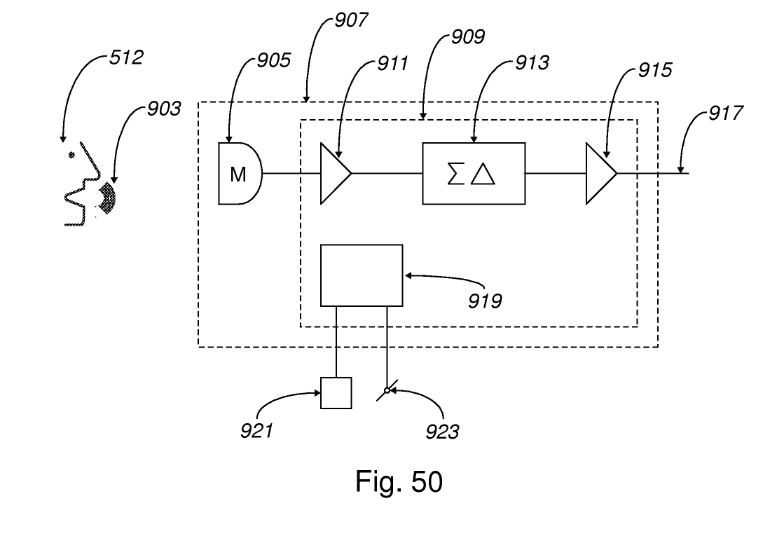

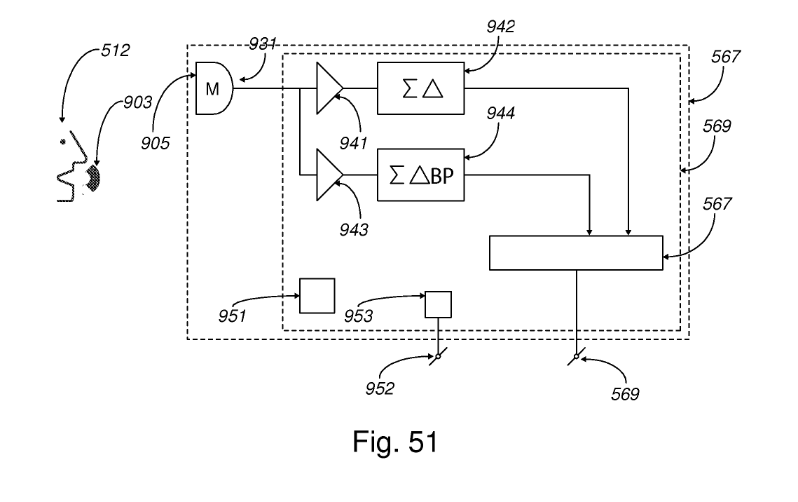

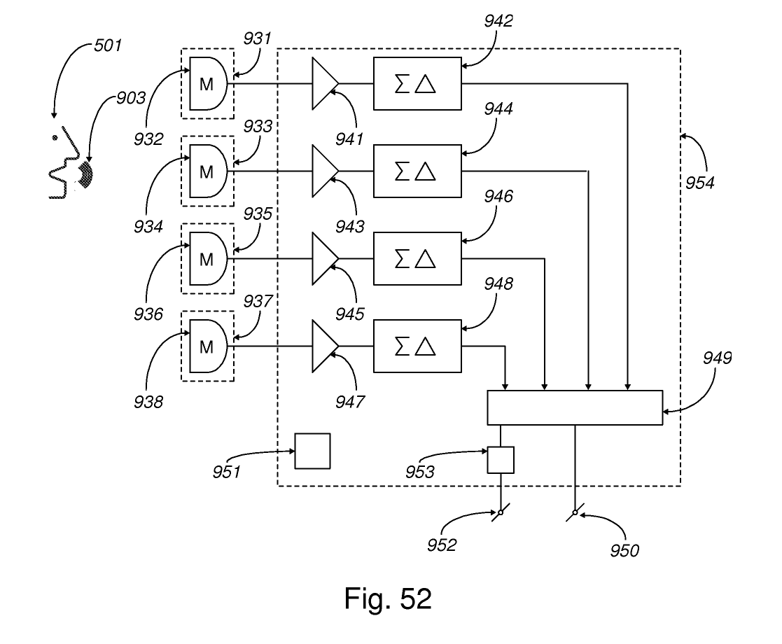

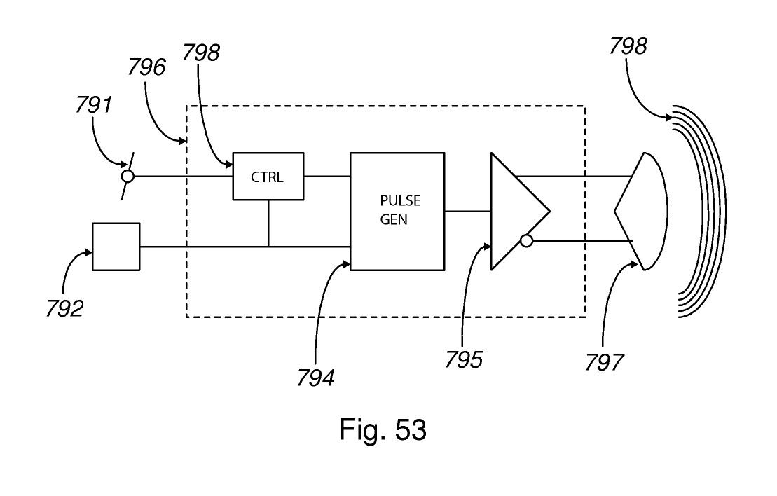

Generally the microphone has response over the human-audible frequency range and also over the range of ultrasound frequencies wherein acoustic signals propagate well in air but do not irritate humans or animals. FIGS. 50 through 52 show arrangements of sigma-delta converters which process signals within the microphone. Other types of converters may be used. Some embodiments employ a MASH 21+1 architecture for sigma-delta element 913 within a configuration similar to FIG. 50.

Ultrasound Transmit Transducer

Referring to FIG. 53, precision of the ultrasound signal packet can be optimized by accurate control of the timing and the drive level of the circuit 796 which drives transducer 797 and generated ultrasound packet 798. It is advantageous to ensure that clock 792 and all other clocks controlling phase of transmitted or received signals are strictly coherent.

The hardware, firmware and software resources described below can support any combination of the preceding embodiments. It will be apparent to those skilled in the art that some embodiments require only a subset of these resources.

The following terms are used herein. COLD START is defined as the sequence of activities that result from turning on the principle source of power. POR is the sequence of operations executed by the PowerOnReset circuit. PWR_OK is the output provided by the POR circuit if it has completed said sequence of operations and has determined that the principle source of power is providing power that is satisfactory. BOOT_DAN is the sequence of operations that enables specified devices within the Device Area Network. TEST is the built-in-self-test sequence which is performed to determine whether or not DAN devices (including the IMT controller) are operating correctly. SOFT FAIL is the flag raised by the TEST circuit if it determines that the DAN is faulty and may be able to repair itself. FIX is the built-in diagnostic circuit which can analyze malfunctions and attempt to repair circuits within the IMT (including those within the DAN). HARD FAIL is the flag raised by the TEST circuit if it determines that the DAN (including the IMT CTRL circuit) is failing and cannot repair itself. SOFT FAIL is the flag raised by the TEST circuit if it determines that the DAN (including the IMT CTRL circuit) is failing and cannot repair itself. ABEND is an Abnormal End. ABEND state is the consequence of a HARD FAIL.

Initialization and Self Test

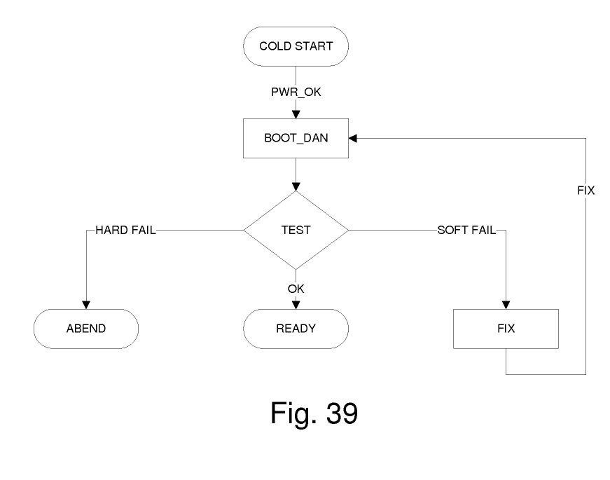

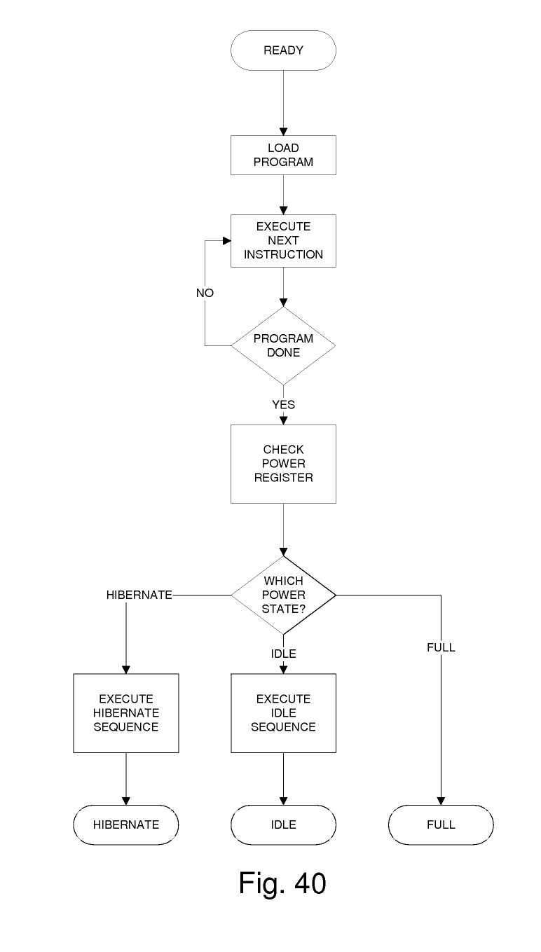

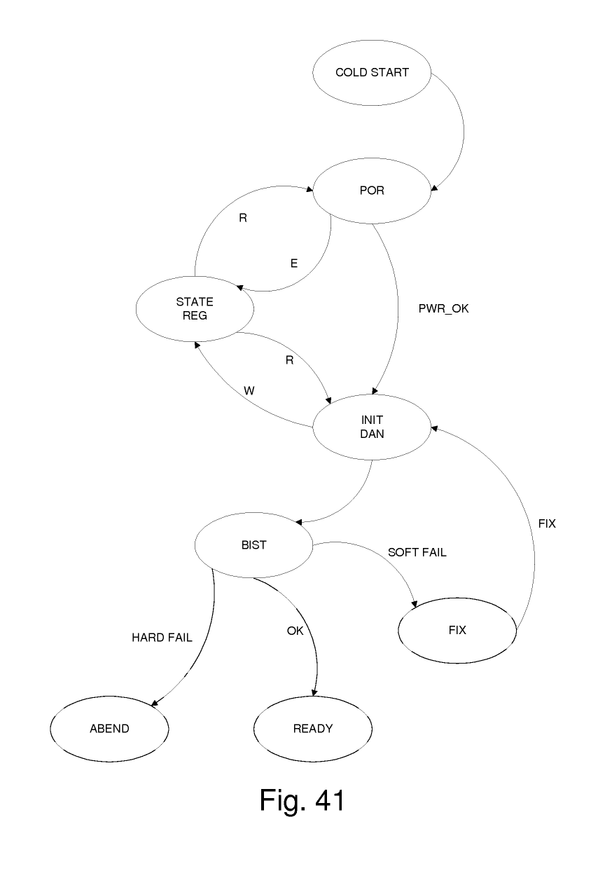

The system boots in the case where there is exactly one external power source. FIG. 39 is a flow chart showing how the control subsystem initializes itself upon power up. FIG. 40 is a bubble diagram showing register-level implementation of the subsystem in said flow chart. Notice that one can exploit redundancy of elements within the IMT system to improve reliability by incorporating diagnosis and repair capabilities.

Initial Configuration

Bits of the STATE register control the exact initialization state. For example, the IMT can be initialized so that it is in hibernation mode, with essentially all power-consuming elements turned off. In this case, the IMT would normally exit the COLD START sequence and be READY, even though it would not actually do anything until it received a control signal at the input of a port that was active while in hibernation mode. A plurality of bits of the STATE register may be reserved to specify which program should be executed upon exit from said COLD_START sequence.

In some embodiments there are multiple external power sources, e.g., in IMT systems where some DAN circuits have power sources separate from the source that powers the IMT CTRL block. In these embodiments, each DAN circuit has either an integral POR circuit or a terminal connected to a POR circuit that is external to said DAN circuit. Said DAN circuits should boot themselves into states that do not cause problems while waiting for the eventual boot of the IMT CTRL block.

Firmware and Software Control

Partial list of functions optionally performed by firmware:

Enumeration of resources within DAN

Calibration, configuration and control of resources within DAN

Calibration, configuration and control of resources external to DAN

Measurement of environmental parameters

Optimization of performance

DAN Prioritization

DAN Arbitration

DAN access control

Interface to external network and devices connected therein

Granting control permission to local users

Granting control permission to external users

How Firmware can be Modified

Firmware can be hard-wired by placing it within ROM installed within the IMT. Alternatively, it can be reconfigurable if loaded within nonvolatile memory installed within the IMT. Said memory can be volatile (such as RAM) or nonvolatile (such as NAND flash). Said reconfiguration can be achieved in a number of ways, including loading software through a network interface, where said network interface is a resource within the DAN, and loading bits that have been generated by programs that run on the IMT.

Security

Optionally, the IMT CTRL circuit contains an encryption circuit.

Discovery

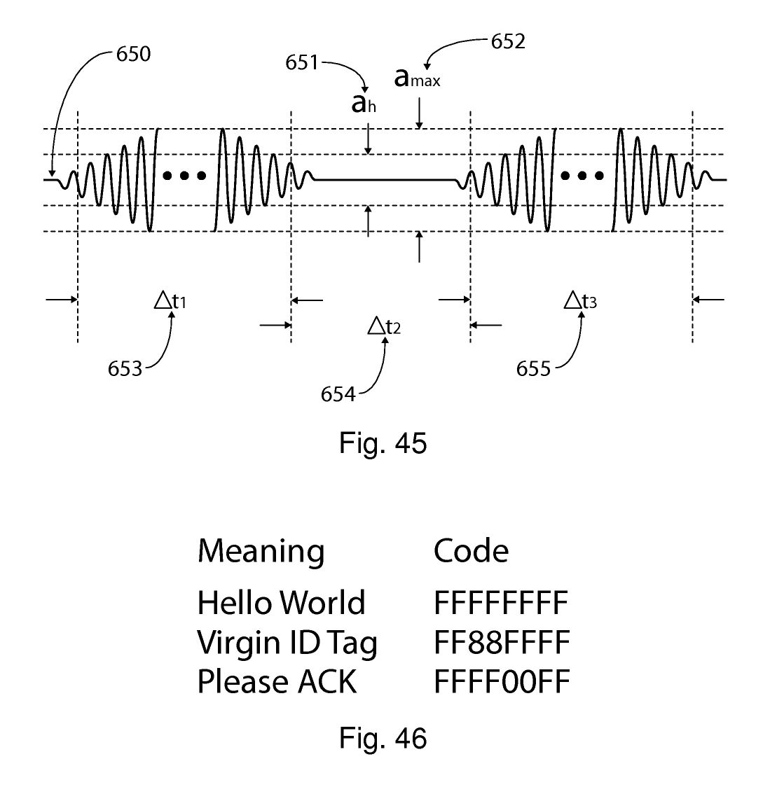

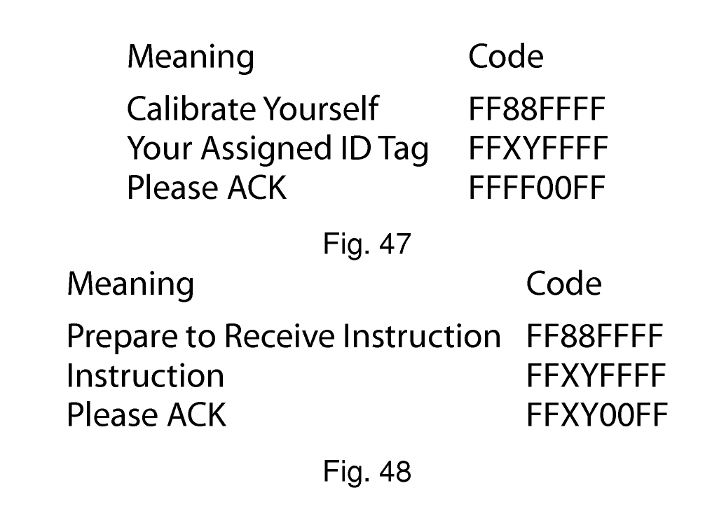

When a new device is brought into the vicinity of the IMT and turned on, the IMT is able to discover said new device and incorporate it within the DAN. FIG. 45 shows the structure of the signals used for discovery, calibration and configuration of devices which join the DAN. Signal 650 can be a packet of ultrasound wavelets or a packet of RF emission. In either case, the duration of successive ON or OFF intervals can be observed by the target device and compared against predetermined thresholds. Accordingly, the target device can observe a series of said intervals and infer the data contained by the ping packet. FIGS. 46-48 show various coding schemes, illustrating that a coding scheme allows devices to extract control information, for example.

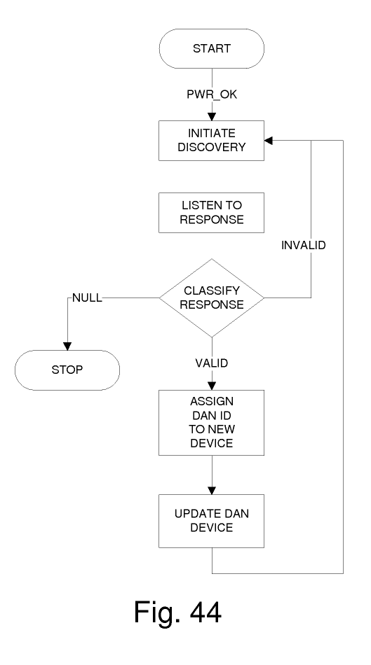

In the unlikely event that ‘hello world’ packets from multiple undiscovered devices overlap, they will generally produce an INVALID response within the Device Discovery logic shown in FIG. 44. Consequently they will remain undiscovered until the discovery process is iterated.

FIG. 45 shows how the undiscovered device will initiate discovery. In general, when an undiscovered device is first powered up or brought into the vicinity of the IMT, it broadcasts a signal within which a virgin ID tag is embedded. All undiscovered devices initially assume the DAN ID field is 88(hex). One or more devices within the DAN will hear the Hello World packet. The first device to hear said packet will respond with a ‘Calibrate yourself’ instruction, followed by a ‘your assigned ID tag’ packet and finally by a ‘please ACK’ packet.

Newly-discovered devices respond to the initial ‘calibrate yourself’ instruction by adjusting the threshold of their receivers. Item 652 within FIG. 45 shows the peak amplitude of the signal. Threshold (651) for the signal is set at a fixed fraction of said peak amplitude. Immediately after said calibration, newly-discovered devices send a ‘please ACK’ packet. If they do not receive prompt acknowledgement, they revert to undiscovered state. If this sequence repeats more than three times, in some embodiments, they stop transmitting packets and enter ABEND state.

Localization

When a new device is discovered, it is advantageous to localize said device. In general, the DAN can achieve said localization by any of the following means. The DAN can use audio transducers (speakers and microphones) which are incorporated as devices within the DAN, in some embodiments. In other embodiments the DAN can use ultrasound transducers. The DAN can also analyze the video signal produced by cameras which are placed in an orientation that allows direct imaging of the newly-discovered device. If the newly-discovered device has an LED or other controllable source of infrared or visible light, analysis of the video signal can be greatly simplified. The DAN can also use TDOA delay measured by RFID chips to triangulate and infer a position of the newly-discovered device. Once the position of the newly-discovered device is known with good precision, it becomes possible to improve localization performance of the DAN by using said device to localize subsequently-discovered devices.

One or more devices within the DAN can ping with packets that contain an address of one or more target devices and instructions on a desired response. Said target devices will respond by emitting packets if instructed to do so. The delay between the time when the target receives the initial ping and the time the target emits said packets can be designed to be determinate and highly reproducible. Furthermore, the medium used for the initial ping can be different from the medium that the target uses for its response. For example, the initial ping can be an RF packet and the response ping can be an ultrasound packet. Consequently the localization can proceed in parallel without ambiguity. The principle motivation for said parallel localization is improvement of speed and precision.

Calibration

Calibration is normally performed under firmware control. Calibration may null out effect of tolerances and variation of on-chip or off-chip components or devices. Calibration can also be used to cancel variation of things that are external to the IMT. For example, the speed of sound can vary as a consequence of humidity, temperature and atmospheric pressure. Calibration can be used to cancel localization errors caused by said variation of the speed of sound. The IMT is able to measure the time required for propagation of an acoustic pulse between points where ultrasound transducers are located. With reference to FIG. 9. if said time between ultrasound transducers 41 and 42 that are physically part of display screen 80 is measured, then the distance between points 41 and 42 can be calibrated.

Access

Programs may grant access that allows devices within DAN or within any external network connected in any way by any device within DAN. To mitigate risk of harmful or malicious use of this access, the IMT controller can use encryption or other security control means. Specifically, the IMT controller can use electronic fingerprints of components within the IMT itself, including any internal or external devices connected thereto by means of DAN or routers or other connective devices that are connected to the DAN.

Local Operation

Referring to FIG. 39, upon completion of the BOOT_DAN process, the IMT is normally in a READY state. The STATE register may contain one or more bits that can be used to launch programs that automatically configure one or more devices attached to the DAN. Among these devices there is normally a terminal or a switch which allows a user to configure and operate the IMT.

Remote Operation

A consequence of said access is that external users, such as persons at the remote end of a teleconference, can alter IMT configuration or optimize IMT performance in order to improve utility of the IMT.

Use-Case Scenarios

Embodiments of the systems described herein are optionally configured to do the following:

Scenarios 1.1-1.4

These scenarios involve users who are passive.

Scenario 1.1

A telepresence user is sitting in front of a 3D display terminal. If the user waves a hand, or makes any other movement that is defined as a gesture, that gesture is recognized by the GRS. A gesture is defined as some physical movement or sequence of movements that the GRS has been programmed or taught to recognize. For example, the 3D display terminal could map a “thumbs-down” gesture to blanking the display and muting the speakers.

Scenario 1.2

A cook is standing in front of a microwave oven, which happens to have a GRS. The cook makes a gesture that tells the oven to slow the cook cycle by ten minutes to accommodate a late guest.

Scenario 1.3

A deaf person uses a GRS to translate sign language to audible form.

Scenario 1.4

A physician in the sterile operating field controls room or operating field lighting, or other non-sterile instruments.

Scenarios 2.1-2.4

In these scenarios the user has an emitter attached to the user's person and is, by definition, ‘active’.

Scenario 2.1

The user wears a ring that emits an acoustic or electromagnetic signal. The ring can be powered by a small battery, or it can harvest energy from its local environment. For example, the ring can contain an integrated circuit that harvests energy from an electromagnetic field at one frequency and uses that energy to transmit a signal at another frequency. Said signal can provide identification information as well as localization information. In the case where the user-worn device emits electromagnetic signals, it is necessary to add corresponding capability for the system to receive these signals.

Scenario 2.2

The user wears a hearing aid including an ultrasound detector means which serves to control settings and operation (e.g. on-off) of the hearing aid. In this case it is desirable to also equip the hearing aid with a means of communicating preferences to the GRS.

Scenario 2.3

The user wears an earring that emits an acoustic or electromagnetic signal. The signal can carry a small ID tag that informs the GRS of essential information as follows: I am an earring on the user's left ear, and the user prefers that loudness is ‘minimum’ and verbosity is ‘learn-mode’

Scenario 2.4

The user wears a wrist band that carries an emitter. The emitter contains apparatus that allows confirmation of his security level and access privileges. Gestures which this user makes will automatically inherit the authorization associated with the emitter.

Scenarios 3.1-3.3

In these scenarios there are multiple users who may be either active or passive. Each active user derives authority (control) associated with the emitter worn on his person.

Scenario 3.1

An Information Technology Administrator wears a ring that contains an RFID tag. Said RFID tag identifies the administrator and securely provides his password to the IMT. Because the GRS securely detects his authority, it is able to accept his gesture and voice commands without first requiring him to log in to the system and confirm his level of authorization. This saves time and allows the administrator to work without accessing a keyboard and mouse.

Scenario 3.2

Utility is also provided in sterile environments, such as an operating room. During surgery, for example, a doctor must not touch objects that are unsterile. Still, the doctor has to control and interact with various instruments. Today, this is generally accomplished by use of foot-activated switches. In principle, a gesture-recognition system allows a more nuanced, reliable and effective means of controlling instruments. A physician in the sterile operating field wears a surgical glove that contains an RFID tag. Because the GRS is able to associate the doctor's gestures with the uniquely identifying RFID tag, the doctor is granted a higher level of authority for asserting control of room or operating field lighting, or other non-sterile instruments.

Scenario 3.3

A bank clerk wears a uniform with a sleeve that contains an RFID tag that identifies the clerk during the present work shift. The clerk works using an IMT that has an integral RFID reader. Every time the clerk enters a command using the gesture recognition system, the clerk's identity is checked and associated with the transaction.

Scenario 4

The IMT discovers external compatible apparatus and augments its capability by incorporating said external apparatus.

Scenario 5

In these scenarios at least one user wears an RFID tag and the IMT discovers external compatible apparatus and augments its capability by incorporating said external apparatus.

Scenario 5.1

A retail clerk wears a uniform that contains an RFID tag that identifies him during the present work shift. The RFID reader in the IMT discovers the clerk and securely connects him to the IMT DAN. The IMT is part of a Point of Sale Terminal (POST). The POST includes one other element that is not part of the IMT. In this specific scenario, the POST includes a scanner which reads bar codes of merchandise scanned by the clerk. The IMT DAN discovers the scanner, verifies its authenticity, and connects it securely to the DAN. As the clerk scans merchandise, each transaction is recorded by the IMT and processed.

Scenario 6

The IMT is used for telepresence. Participants in said telepresence communication can optimize system performance by controlling configuration of IMT both at local and remote nodes.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

Computing and computation systems referred to herein can comprise an integrated circuit, a microprocessor, a personal computer, a server, a distributed computing system, a communication device, a network device, or the like, and various combinations of the same. Such systems may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing analog or digital information, such as in a database. The systems can comprise hardware, firmware, or software stored on a computer-readable medium, or combinations thereof. A computer-readable medium, as used herein, expressly excludes paper and carrier waves. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

What is claimed is:

1. A gesture recognition system comprising:
one or more spatially-distributed acoustic emitters each configured for sending an ultrasonic acoustic signal;
a plurality of spatially distributed receivers each configured for receiving echoes produced when said acoustic signal is reflected by one or more spatially distributed objects and further configured to receive audible acoustic signals;
a timing-control circuit configured for controlling timing of emission of acoustic signals at each of the acoustic emitters and measuring timing of receipt of acoustic signals received at each of the receivers; and
a computing device configured to calculate characteristic information regarding the spatially distributed objects that reflect acoustic energy, to transform the characteristic information into a matrix of bits and to store the matrix of bits in memory, the characteristic information including a human gesture.

2. The system of claim 1, wherein each of the receivers comprises a microphone configured to detect ultrasonic sound and a microphone configured to detect audible sound.

3. The system of claim 1, wherein the receivers are further configured to operate as an audio input for a telephone or video conferencing system.

4. The system of claim 1, wherein said signal comprises a series of wavelets spaced in time such that the interval between wavelets is larger than the quotient of path delay divided by a maximum round-trip path length from emitter to object to receiver.

5. The system of claim 4, wherein the series of wavelets are emitted in sequential manner by a plurality of transducers within at least one of the spatially distributed objects.

6. The system of claim 1, wherein the plurality of receivers includes an array of elements comprised of MEMS microphones connected to sigma-delta converters configured to produce phase-coherent digital representation of the acoustic energy detected at each receiver.

7. The system of claim 1, wherein said emitters include a plurality of audio transducers configured to generate human-audible sounds and also generate ultrasound.

8. The system of claim 1, wherein the computing device is configured to reject receiver measurements that do not correspond to echoes produced by acoustic reflections.

9. A gesture recognition system comprising:
one or more spatially-distributed acoustic emitters configured to send acoustic signals;
a plurality of spatially distributed receivers configured for receiving echoes produced when the acoustic signal is reflected by a plurality of spatially distributed objects;
a timing-control circuit configured to control timing of emission of the acoustic signals, to measure timing of receipt of the echoes received at each of the receivers; and
a computing device configured to accurately determine characteristic information regarding the spatially distributed objects based on the received echoes and to recognize a gesture made with a human hand based on the characteristic information.

10. The system of claim 9, further comprising a display, movement of a cursor on the display being responsive to the gesture.

11. The system of claim 9, wherein the computing device is configured to turn on the display in response to the gesture.

12. The system of claim 9, further comprising a camera, wherein the computing device is configured to use both image data collected by the camera and the characteristic information to recognize the gesture.

13. The system of claim 12, wherein the camera is configured to detect infrared light.

14. The system of claim 9, wherein at least one of the objects includes an object worn by a person.

15. The system of claim 9, wherein at least one of the objects is configured to emit a radio or acoustic signal.

16. The system of claim 9, wherein the characteristic information includes data characterizing a location and a shape of at least one of the objects.

17. The system of claim 9, wherein the characteristic information includes data characterizing a movement of at least one of the objects.

18. The system of claim 9, wherein the computing device is configured to control the display in response to the gesture.
